(19) United States
(12) Patent Application Publication
(10) Pub. No.: US 2025/0108832 A1
(43) Pub. Date: Apr. 3, 2025

(54) MOTION PREDICTION AND TRAJECTORY GENERATION FOR MOBILE AGENTS

(71) Applicant: Five AI Limited, Cambridge (GB)

(72) Inventors: Morris Antonello, Cambridge (GB); Mihai Dobre, Cambridge (GB); Stefano Albrecht, Cambridge (GB); John Redford, Cambridge (GB); Subramanian Ramamoorthy, Cambridge (GB); Steffen Jaekel, Cambridge (GB); Majd Hawasly, Cambridge (GB)

(73) Assignee: Five AI Limited, Cambridge (GB)

(21) Appl. No.: 18/728,430

(22) PCT Filed: Jan. 13, 2023
(86) PCT No.: PCT/EP2023/050774

§ 371 Date: Jul. 11, 2024

(30) Foreign Application Priority Data
Jan. 13, 2022 (GB) 2200416.2
Feb. 28, 2022 (GB) 2202751.0

(51) Int. Cl. B60W 60/00; G06V 10/82; G06V 20/56

(52) U.S. Cl. CPC B60W 60/0011; B60W 60/0013; B60W 60/00274; G06V 10/82; G06V 20/588; B60W 2420/403; B60W 2552/53; B60W 2554/4045; B60W 2556/10

(57) ABSTRACT

One aspect herein pertains to a computer-implemented method of predicting agent motion comprises receiving a first observed agent state corresponding to a first time instant; determining a set of agent goals; for each agent goal, planning an agent trajectory based on the agent goal and the first observed agent state; receiving a second observed agent state corresponding to a second time instant later than the first time instant; for each goal, comparing the second observed agent state with the at least one agent trajectory planned for the goal, and thereby computing a likelihood of the goal and/or the planned agent trajectory for the goal. Another aspect pertains to trajectory generation, e.g., within a motion planner.

### TECHNICAL FIELD

The present disclosure pertains generally to motion prediction. The motion prediction techniques have applications in autonomous driving and robotics more generally, for example to support motion planning in autonomous vehicles and other mobile robots. The present disclosure also pertains to trajectory generation, with applications in motion prediction but also other aspects of mobile robotics such as motion planning.

### BACKGROUND

There have been major and rapid developments in the field of autonomous vehicles. An autonomous vehicle (AV) is a vehicle which is equipped with sensors and control systems which enable it to operate without a human controlling its behaviour. An autonomous vehicle is equipped with sensors which enable it to perceive its physical environment, such sensors including for example cameras, radar and lidar. Autonomous vehicles are equipped with suitably programmed computers which are capable of processing data received from the sensors and making safe and predictable decisions based on the context which has been perceived by the sensors. An autonomous vehicle may be fully autonomous (in that it is designed to operate with no human supervision or intervention, at least in certain circumstances) or semi-autonomous. Semi-autonomous systems require varying levels of human oversight and intervention. An Advanced Driver Assist System (ADAS) and certain levels of Autonomous Driving System (ADS) may be classed as semi-autonomous. A “level 5” vehicle is one that can operate entirely autonomously in any circumstances, because it is always guaranteed to meet some minimum level of safety. Such a vehicle would not require manual controls (steering wheel, pedals etc.) at all. By contrast, level 3 and level 4 vehicles can operate fully autonomously but only within certain defined circumstances (e.g. within geofenced areas). A level 3 vehicle must be equipped to autonomously handle any situation that requires an immediate response (such as emergency braking); however, a change in circumstances may trigger a “transition demand”, requiring a driver to take control of the vehicle within some limited timeframe. A level 4 vehicle has similar limitations; however, in the event the driver does not respond within the required timeframe, a level 4 vehicle must also be capable of autonomously implementing a “minimum risk maneuver” (MRM), i.e. some appropriate action(s) to bring the vehicle to safe conditions (e.g. slowing down and parking the vehicle). A level 2 vehicle requires the driver to be ready to intervene at any time, and it is the responsibility of the driver to intervene if the autonomous systems fail to respond properly at any time. With level 2 automation, it is the responsibility of the driver to determine when their intervention is required; for level 3 and level 4, this responsibility shifts to the vehicle's autonomous systems and it is the vehicle that must alert the driver when intervention is required. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

Motion prediction is receiving significant attention because of the need for reactive decision making in numerous robotics applications. For example, an autonomous vehicle or other mobile robot (the ego vehicle/robot) needs the ability to make motion predictions about other agents (other vehicles, pedestrians etc.) to support its own motion planning. Motion prediction of road users in traffic scenes is critical for autonomous driving systems that must take safe and robust decisions in complex dynamic environments. In autonomous driving, a key aspect of motion prediction is the problem of inferring the future states of road users in the traffic scene. Navigating complex dynamic environments in a safe and efficient manner requires a mobile robot to observe, reason about and respond to relevant objects or hazards along the way. Complex reasoning, such as when to perform maneuvers or low-level path planning optimizations, is not possible without making predictions about various properties of interest, such as future goals and trajectories of other agents. Certain motion planning algorithms rely on motion prediction for the reliable estimation of future goals and trajectories of the surrounding road users.

In motion planning, a planner is required to generate a trajectory for an ego agent that is safe and which typically should satisfy other constraints such as comfort and progress towards some defined goal, e.g. characterised by a goal location or lane identifier. Typically, a planner would be supported by motion prediction, whereby the predicted trajectories of other agents may be used to generate an appropriate trajectory for the ego agent.

### SUMMARY

Trajectory generation in the context of motion prediction is considered. Trajectory generation is also considered more broadly in other aspects, including applications to motion planning, where a trajectory generator is used to generate a trajectory for an ego agent.

A first aspect herein pertains to motion prediction, and is directed to a computer-implemented method of predicting agent motion, the method comprising: receiving a first observed agent state corresponding to a first time instant; determining a set of agent goals; for each agent goal, planning an agent trajectory based on the agent goal and the first observed agent state; receiving a second observed agent state corresponding to a second time instant later than the first time instant; for each goal, comparing the second observed agent state with the at least one agent trajectory planned for the goal, and thereby computing a likelihood of the goal and/or the planned agent trajectory for the goal.

When used in relation to the broader principles of the present disclosure, the term “likelihood” is used in the everyday sense of the word. That said, an example Bayesian inverse planning approach is described below, where the likelihood of the goal is determined as the likelihood (in the Bayesian sense) of a set of one or more observations (the second observed agent state and, optionally, any other pertinent observation(s)) if the agent were planning towards the goal in question (or following the planned agent trajectory associated with the goal).

Certain described embodiments provide a form of motion prediction, in which future states of other agents are predicted in real-time for motion planning, using what is referred to herein as “Bayesian inverse planning”. A combination of route planning and map information gives a set of possible goals. Observations of agent traces support reasoning over paths and probabilistic inference of agent goal intention, which in turn support agent action prediction. A trace refers to an observed historical spatial and motion state of an agent, or a sequence of such states. Agent goals are generated automatically using a scenario query engine on a lane graph describing the topology of a road layout.

In embodiments, the second observed agent state may be compared with the agent trajectory, by determining a probability distribution based on a predicted state of the agent trajectory corresponding to the second time instant, and computing a likelihood of the second observed agent state based on the probability distribution.

The agent may be located in a road layout having an associated lane graph, and the agent goals may be determined by performing a search of the lane graph based on the first observed agent state.

A goal posterior probability may be computed based on the likelihood of the goal and a prior for the goal.

The above steps may be repeated over multiple time steps, with the second observed agent state in a given time step becoming the first observed agent state in the next time step.

The above goal prior may be determined based on the goal probabilities from the previous time steps (e.g. smoothed with a forgetting factor).

The goal/trajectory likelihood may be biased to penalize for lack of comfort. For example, an unbiased likelihood may be determined by comparing the second observed agent state with the trajectory, and a biased likelihood may be obtained by applying a weighting factor that penalizes lack of comfort.

The method may comprise providing, to a motion planner, the trajectory and the goal/trajectory likelihood for at least one goal.

More generally, a prediction (e.g. probabilistic prediction) comprising or based on the trajectory and the goal/trajectory likelihood may be provided to a motion planner (depending on the construction of the planner).

Multiple trajectories may be planned for each goal.

Each goal may be defined by a goal location. In the following description, the term “hypothesis” may be used to refer to the high-level intent of an agent, and the goal location may be referred to simply as the goal for conciseness.

In a second aspect, a computer-implemented method of predicting agent motion comprises: receiving a first observed agent state corresponding to a first time instant; determining a set of agent goals for an agent located in a road layout having an associated lane graph, by performing a search of the associated lane graph based on the first observed agent state; for each agent goal, planning an agent trajectory based on the agent goal and the first observed agent state; receiving a second observed agent state corresponding to a second time instant later than the first time instant; and for each goal, comparing the second observed agent state with the at least one agent trajectory planned for the goal, and thereby computing a likelihood of the goal and/or the planned agent trajectory for the goal.

In embodiments, the search of the associated lane graph may comprise exploring traversals through the lane graph from the second observed agent state up to a predetermined distance.

The method may be repeated over a sequence of time steps, with the second observed agent state in a given time step becoming the first observed agent state in the next time step.

Each goal may be defined as a sequence of lane identifiers determined from the lane graph, wherein at least one goal is matched with a goal extracted in a previous time step by comparing the respective sequences of lane identifiers defining those goals.

The method may comprise comparing the second observed agent with the agent trajectory, by determining a probability distribution based on a predicted state of the agent trajectory corresponding to the second time instant, and computing a likelihood of the second observed agent state based on the probability distribution.

A goal or trajectory posterior probability may be computed based on the likelihood of the goal and a prior for the goal or trajectory.

The goal or trajectory prior may be based on a goal or trajectory posterior probability from the previous time step.

For example, the goal or trajectory prior of the above at least one goal may be based on the goal or trajectory posterior probability of the goal from the previous time step to which it has been matched

The goal or trajectory posterior probability from the previous time step is smoothed with a forgetting factor.

Responsive to a change in the set of agent goals relative to the previous time step, the change being a removal of a goal that is no longer achievable or the addition of a new goal, the goal or trajectory posterior for each remaining goal or trajectory may be updated to account for the removed goal or the new goal.

The goal or trajectory likelihood may be biased by applying a weighting factor that penalizes the planned agent trajectory for lack of comfort. For example, the weighting factor may penalize lateral acceleration on the planned agent trajectory that is above a lateral acceleration threshold

The agent trajectory may be planned using a target path extracted based on a geometry of the road layout and a motion profile generated using a neural network.

The neural network may generate the motion profile but may not generate any path, and the target path and the motion profile may be provided to a classical trajectory planner which plans the agent trajectory based on the motion profile and the target path.

The classical trajectory planner may, for example, use a controller and an agent dynamics model to generate a trajectory that minimises error from the motion profile and the target path.

The method may comprise determining a context for the agent, and selecting the neural network from a collection of neural networks based on the determined context.

For example, the context may be based on the goal and the number of other agents surrounding the agent.

A third aspect provides a computer-implemented method of predicting agent motion, the method comprising: receiving a first observed agent state corresponding to a first time instant; determining a set of agent goals; for each agent goal, planning an agent trajectory based on the agent goal and the first observed agent state; receiving a second observed agent state corresponding to a second time instant later than the first time instant; for each goal, comparing the second observed agent state with the at least one agent trajectory planned for the goal, and thereby computing an unbiased likelihood of the goal and/or the planned agent trajectory for the goal; and obtaining a biased likelihood by applying a weighting factor to the unbiased likelihood that penalizes lack of comfort.

The weighting factor may penalize lateral acceleration on the planned agent trajectory that is above a lateral acceleration threshold.

A fourth aspect provides a computer-implemented method of predicting agent motion comprising: receiving a first observed agent state corresponding to a first time instant; determining a set of agent goals; for each agent goal, planning an agent trajectory based on the agent goal and the first observed agent state, using a path extracted based on a geometry of the road layout and a motion profile generated using a neural network; receiving a second observed agent state corresponding to a second time instant later than the first time instant; for each goal, comparing the second observed agent state with the at least one agent trajectory planned for the goal, and thereby computing a likelihood of the goal and/or the planned agent trajectory for the goal.

In embodiments, the neural network may generate the motion profile but may not generate any path, and the target path and the motion profile may be provided to a classical trajectory planner which plans the agent trajectory based on the motion profile and the target path.

Any of the above aspects or embodiments may be implemented in an autonomous stack for an ego robot, in which a planner of the autonomous stack plans an ego trajectory for the ego robot based on the predicted agent motion.

A controller of the autonomous stack may generate based on the planned ego trajectory a control signal for controlling motion of the ego robot.

A fifth aspect provides a computer-implemented method of generating an agent trajectory for a mobile agent, the method comprising generating an agent trajectory for a mobile agent based on an agent goal, using a path extracted based on a geometry of the road layout and a motion profile generated using a neural network.

The neural network may generate the motion profile but not any path, and the target path and the motion profile may be provided to a classical trajectory planner which plans the agent trajectory based on the motion profile and the target path.

The classical trajectory planner may use a controller and an agent dynamics model to generate a trajectory that minimises error from the motion profile and the target path.

The method may comprise determining a context for the agent, and selecting the neural network from a collection of neural networks based on the determined context.

The neural network may receive as input a set of agent features and a representation of the target path.

The target path may be extracted based on the geometry of the road layout and the agent goal.

The method may be used in planning motion of the mobile agent, the method comprising generating based on the generated trajectory a control signal for controlling motion of the mobile agent.

Alternatively, the method may be used in predicting motion of the mobile agent for planning motion of an ego agent, in which a planner of the autonomous stack receives the generated trajectory for the mobile agent and uses the generated trajectory to plan an ego agent trajectory.

Further aspects herein provide a computer system comprising one or more processors configured to implement the method of any preceding aspect or embodiment, and a computer program for programming a computer system to implement the same.

For a better understanding of the present disclosure, embodiments will now be described by way of example only, with reference to the following figures in which:

### BRIEF DESCRIPTION OF FIGURES

FIG. 1 shows a schematic block diagram of an inverse planning prediction system;

FIG. 2 shows a portion of a road layout with goals extracted at different time steps;

FIG. 3 shows an agent and a target path annotated with certain parameters used in classical trajectory generation;

FIG. 4 shows a schematic view of an agent annotated with parameters of a kinematic motion model describing motion of the agent;

FIG. 5 shows graphs of comparison data for follow-lane models for motion profile prediction;

FIG. 6 shows a second road layout with trajectories generated based on extracted goals at different time steps;

FIG. 7 shows example violations of kinematic and motion profile constraints;

FIG. 8 shows a schematic plan view of a driving scene at incrementing time steps;

FIG. 9 shows a schematic block diagram of an autonomous vehicle stack;

FIG. 10 shows a schematic overview of certain principles of Bayesian belief estimation;

FIG. 11 depicts example situations where extended agent reasoning may be appropriate;

FIGS. 11A-B shows show two examples of path and goal extraction involving agents on an oncoming lane;

FIG. 11C shows a roundabout scenario, in which agents can be predicted outside a road layout;

FIG. 12 shows a schematic block diagram of a scenario access system;

FIG. 13 shows an example road network;

FIG. 14 shows part of a road network annotated with OpenDRIVE elements used to describe the road network;

FIG. 15 shows a lane graph extracted from a static road layout; and

FIG. 15A shows part of a lane graph with associated edge costs.

### DETAILED DESCRIPTION

Embodiments are described in the context of motion prediction. However, as described in further detail below, certain described elements also have application in motion planning.

Motion prediction of road users in traffic scenes is critical for autonomous driving systems that must take safe and robust decisions in complex dynamic environments.

Motion prediction is challenging because of the multitude of factors that determine future behaviour, not all of which may be explicitly modelled. Algorithms are expected to generalize to different environmental situations, such as a wide range of different layouts including merges, junctions, roundabouts etc. Combined with varying intentions and behaviours of different agents, this can result in many possible future outcomes that need to be captured. Furthermore, low-level aspects that affect the possible future trajectories, such as vehicle characteristics (e.g. dimensions, turning circle etc), type of vehicle (e.g. emergency services, transport, motorbikes etc.) and driving styles (e.g. aggressive versus conservative), further increase the resulting uncertainty. Besides multimodality and spatial uncertainty, using motion prediction within a safety critical and real-time motion planning system extends the list of requirements. System maintainability and physical realism are additional qualities of interest which are less frequently addressed [5], e.g. many state-of-the-art methods, such as [6], [7], [8], [9], are end-to-end regression based systems which might not produce physically-feasible trajectories. As described in [10], machine learning systems can incur massive maintenance costs because of system-level anti-patterns, such as entanglement which prevents isolated improvements.

A ‘hybrid’ motion prediction system for autonomous driving, referred to herein as ‘Flash’, is described. The described system addresses multiple aspects of interest, namely multi-modality, motion profile uncertainty and trajectory physical feasibility. We report on several experiments with the popular highway dataset NGSIM, demonstrating state-of-the art performance in terms of trajectory error. A detailed analysis of the system's components is provided, along with experiments that stratify the data based on behaviours, such as change-lane versus follow-lane, to provide insights into the challenges in this domain. A qualitative analysis is also presented to show other benefits of the present approach, such as the ability to interpret the outputs.

The described motion prediction system is based on a Bayesian inverse planning framework, which efficiently orchestrates map-based goal extraction, a classical control-based trajectory generator and a ‘mixture of experts’ collection of light-weight neural networks specialised in motion profile prediction. In contrast to many alternative methods, this modularity helps isolate performance factors and better interpret results, without compromising performance.

One example implementation of a Bayesian Inverse Planning algorithm may be summarized as follows. The algorithm operates over a sequence of time steps, and each time step involves the following operations:
a. Determine hypotheses from agent state and road layout: lane follow, stand still, lane change, take any possible roundabout or junction exit etc.
b. Instantiate agent goal for each hypothesis based on the road layout and observed current agent state.
c. Run motion planning to obtain 1+trajectories for each hypothesis.
d. Observe next agent state.
e. Compare newly observed agent state with hypothesised plans to update beliefs over hypotheses, returning a distribution over goals and trajectories
f. Repeat a-e for next time step.

Inverse planning is modular and its components (hypothesis generation, trajectory generation and belief estimation) can be isolated, executed and modified independently.

The hybrid nature of the system allows the inclusion of light-weight machine learning models. In a hybrid system, performance factors may be more readily isolated and components may be replaced more easily. Results are more interpretable, including while demonstrating state-of-the art performance.

The described prediction system is general and can address the majority of the previously described challenges. We evaluate our method in the highways setting, which defines a microcosm of the complex dynamics that one expects to find in everyday driving [11]. Highways include multiple lanes; space-sharing conflicts are common between the on-ramp vehicles and vehicles on the outermost lane and, similarly, during change-lane and overtaking behaviours when vehicles need finding suitable gaps while maintaining safety distances.

As noted, Flash is a novel hybrid motion prediction system that is based on the Bayesian inverse planning framework. It efficiently orchestrates map-based goal extraction, a classical control-based trajectory generator and a mixture of experts collection of light-weight neural networks specialised in motion profile prediction. This system models properties of interest such as multimodality and motion profile uncertainty while providing strong guarantees that kinematic and motion profile constraints are respected.

We evaluate the system thoroughly on a popular highway dataset-NGSIM [12], comparing with alternative multimodal methods. Flash improves the state-of-the art trajectory error reported in [7] by 9.05% for a 5 second prediction horizon, it guarantees kinematic and motion profile constraints by construction, and its training is 96.92% faster than in [9]. We analyse single components such as motion profile prediction and Bayesian inference, showing that the modularity helps isolate performance factors and interpret predictions.

Reference is made to International Patent Publication Nos. WO 2020/079066 and WO2021/073781, the contents of each of which is incorporated herein by reference in its entirety. An inverse planning prediction methodology described therein, and certain features of that methodology are developed herein. Inverse planning is a prediction methodology that assumes a mobile agent (such as a vehicle or other road user) plans rationally towards some defined goal. The term “inverse planning prediction” may also be used herein.

In summary, one implementation of inverse planning used herein works as follows at each time step:
a. Determine applicable behavioural hypotheses based on current agent state and road layout: lane follow, lane change, take any possible roundabout or junction exit etc.
b. Instantiate agent goal state per hypothesis based on the road layout and observed current agent state.
c. Run motion planning to obtain 1+possible trajectories for each hypothesis
d. Observe next agent state
e. Compare newly observed agent state with hypothesised plans (behavioural hypothesis) to update beliefs over hypotheses.
f. Repeat a-e for next time step, based on updated agent location and goals.

The described system includes a goal extraction capability, in which possible goals of agents are extracted from a lane graph that describes a lane topology of a driving scene. The lane graph described connections between lanes from the perspective of a road user.

In this respect, reference is also made to United Kingdom Patent Application No. GB2114685.7, the contents of which is incorporated herein by reference in its entirety. A scenario query engine (SQE) is disclosed therein, which generates a queryable a lane graph from a road network contained in a static layer, such as an OpenDrive specification or other form of road map. As described in further detail below, goal discovery to support inverse planning is described based on traversal of a lane graph for a driving scene. The ‘side-lane’ terminology of OpenDrive is used in various places herein.

A path may be defined as a sequence of poses (position and yaw) and each prediction goal is identified by a respective lane ID (road id, lane section index and lane id). Given a detection, all paths from a detection pose to a predefined distance may be estimated from the detection speed and acceleration, thus identifying the respective goals.

As noted above, in a Bayesian inverse planning approach is described below, the likelihood of a goal may be determined as the likelihood (in the Bayesian sense) of a set of one or more observations (the second observed agent state and, optionally, any other pertinent observation(s)) if the agent were planning towards the goal in question (or following the planned agent trajectory associated with the goal). This may be denoted in mathematical notation as P(O2|T) where T denotes the trajectory in question and O2 denotes the second observed agent state (and any other observations that may or may not be utilized). If a single trajectory is generated per goal, this is equal to the probability P(O2|G) of the observation G2 given the goal G. With multiple trajectories, a distinction may be drawn between the goal likelihood P(O2|G) and the likelihood of a trajectory P(O2|T) associated with a goal.

With trajectory T is defined as a sequence of timestamped agent states, such as timestamped poses P (position+yaw), in computing the likelihood, the observation O2 (e.g. observed position+yaw from velocity direction) at time t2 is compared with the respective pose P2 at time t2 along the previously predicted trajectory (as predicted for time t1). This could also be called the likelihood p(O2|P2) of the observed state O2 at time t2 given the predicted state P2 (that is, the state the agent was predicted to be in at time t2 based on the earlier observation(s) available at time t1). In some embodiments, a normal distribution with mean P2 is assumed. Note that this is done for each goal/trajectory. Each goal/trajectory likelihood might be greater than 1 and the likelihoods will not sum up to 1. However, probabilities and a distribution over goals/trajectories, may be obtained by normalizing the likelihoods.

The algorithm then continues by replanning a trajectory covering the future timesteps starting from t2. At the start of each new planning step, the lane graph is re-explored to discover any goals at time t2. That is, a set of agent goals is determined at each time step, based on the current state of the agent and the lane graph. From the perspective of the ego vehicle, the scene (and, in particular, the map/road layout) changes as the ego vehicle travels. Since perceived detections can jump around because of noise, it is possible to discover new goals, i.e. different from the previous goals (at time t1), which need to be matched to the previous goals (from time t1). Goal matching means it is possible to re-use a previous posterior (over the previous goals at time 1) as prior (over the new goals at time 2). Since each goal is discovered by traversing the lane graph, the graph traversals that lead to the goals—each defined as sequence of (OpenDrive) lane IDs—can be compared to find the best match between goals at time 1 and goals at time 2. There can be edge cases that cause an ambiguous match, e.g. a very noisy detection jumping a lot. These cases are handled by falling back to a uniform distribution as prior since it is conservative.

If lateral acceleration of the trajectory is above a threshold at any time in the predicted short term, a weight is multiplied that decreases the goal/trajectory probability. Strictly speaking, this weight is a function of the excess in lateral acceleration and the function is an exponential decay: the bigger the excess with respect to the max acceptable lateral acceleration, the less likely it is. As before, this is done for each trajectory/goal and, to get probabilities, the final values are normalized.

Lateral acceleration is one way of quantifying comfort along a trajectory, and penalizing for lack of comfort. The less comfortable the trajectory (or, more precisely, the greater the extent to which it exceeds some defined comfort threshold), the less likely it is. As will be appreciated, lateral acceleration is merely one metric that can be used to quantify comfort. Other comfort metric(s) can be used, individually or in combination, to penalize trajectories, such as lateral jerk (rate of change of lateral acceleration).

The summary above refers to “trajectory/goal”. In implementations that generate a single trajectory per goal, “goal” and “trajectory” are interchangeable when referring to likelihoods, as this simplification means that the probability of a goal equals the probability of the respective trajectory.

In other implementations, which generate multiple trajectories per goal, both trajectory and goal likelihoods could be estimated, and the predicted distribution could be provided to a planner. For example, with a finite number of trajectories, e.g. generated using a bank of physics-based models or considering multiple future sequences of maneuvers, their individual likelihoods may still be estimated by comparing observations with trajectories together with rewards/costs. Neural network models for motion profile generation are also considered.

A goal distribution may still be determined. For example it could be estimated by aggregating all trajectory likelihoods or by comparing observations with paths (instead of trajectories). This goal distribution could be used by a planner like the interactive planner to explore consistent futures where the predicted agents don't change goals during the planning horizon, e.g. in the context of the MCTS algorithm described in WO2021/073781.

A Bayesian form of Inverse Planning Prediction is described, which uses a Pure-Pursuit Trajectory Generator and Kinematic Models. This model performs multimodal prediction by taking a Bayesian inverse planning approach. In order to predict the future of each agent, the model begins by hypothesising a map-based collection of goals for each of them. It then develops a physically feasible plan for how each agent might reach any given goal, and assesses the likelihoods by comparing the plans to agent observations. Finally, a joint distribution over goals and trajectories is inferred for each agent by inverting the planning model using Bayesian inference, integrating the likelihood with the prior.

Holistic prediction implementations are also considered, which generally encompasses the use of multiple predictors for different cases. Holistic prediction refers to a system (e.g. software system) coordinating multiple predictors so that all cases of interest get covered. For example, separate predictors for Vulnerable Road Users (e.g. kinematic prediction or appearance-based predictor) and for vehicles (e.g. inverse planning with kinematic models, inverse planning with learned models) may be provided. As will be appreciated, this is merely one example. Inverse planning could be used for VRUs and/or appearance-based models could be for some vehicles. A holistic prediction system coordinates the available predictors.

In contrast to deep neural networks, this approach is based on an interpretable algorithm. Relying on maps, physics-based models and trajectory generation algorithms, it generalizes to new environments and situations without training data while satisfying physical realism guarantees by construction. The model parameters have a physical meaning and they can be tuned on datasets without sacrificing interpretability. Neural network based models are also considered for motion profile generation, and such models have certain benefits described herein. The relative performance of physics-based and neural network models is compared in our experiments.

In contrast to other methods, this implementation predicts each agent independently. Traffic context, e.g. the motion and relative spatial configuration of neighbouring agents, or future interactions with other agents are not considered. This simplification reduces the computational requirements.

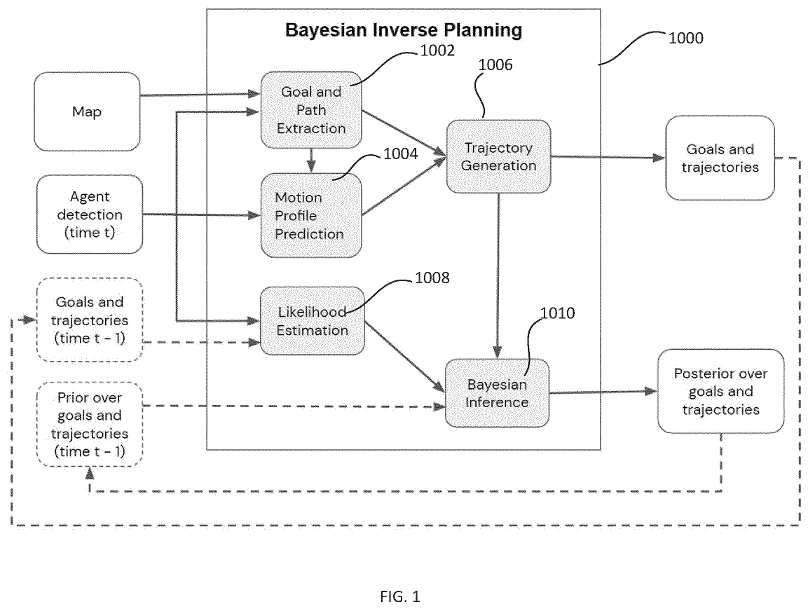

FIG. 1 shows a schematic block diagram of the motion prediction system, denoted by reference sign 1000. The system 1000 is shown to comprise five main components: 1) goal and path extraction (1002), 2) motion profile prediction (1004), 3) trajectory generation (1006), 4) likelihood estimation (1008) and 5) Bayesian inference (1010).

Given a detection pose and a map that describes the geometry of roads and lanes, their properties, e.g. lane types, and how they are interconnected with each other, goals are extracted by exploring all lane graph traversals up to a distance. The SQE lane graph may be used for this purpose.

For example, in highway situations, goals may correspond to staying in the lane, changing to a neighbouring lane, entering the highway or exiting it. For each goal, reference path(s) are extracted from lane midlines and combined with target motion profiles, e.g. a sequence of acceleration inputs (and/or other motion values), to generate trajectories. In the described implementation, a single goal-directed trajectory is generated for each goal/reference path, using a pure pursuit controller, which can enforce a bicycle model and kinematic limits, e.g. maximum steering and accelerations. Pure pursuit is a path tracking algorithm, calculating the curvature that will move an agent from its current position to a target position at a distance ahead (similarly, when humans drive, they look at a point they want to go to and control the car to reach it).

Further details of the pure pursuit controller may be found at https://www.ri.cmu.edu/pub_files/pub3/coulter_r_craig_1992_1/coulter_r_craig_1992_1.pdf, which is incorporated herein by reference in its entirety.

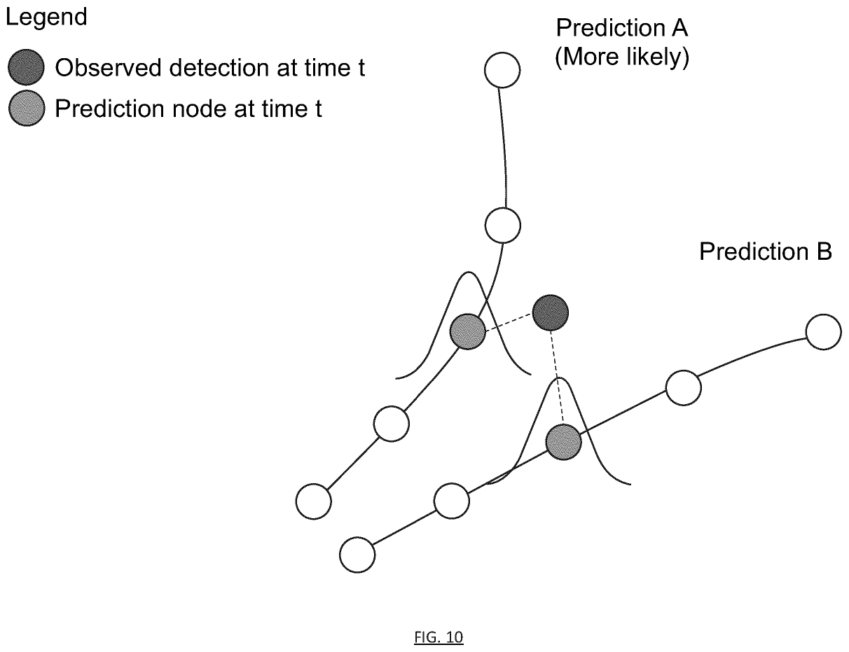

FIG. 10 shows a schematic overview of certain principles of Bayesian belief estimation.

Likelihood estimation assumes a gaussian distribution on agent position and yaw, estimated from velocity direction.

In posterior estimation (posterior=prior*likelihood), with smoothing using a forgetting factor (see below), to allow previous likely hypotheses to be forgotten, enabling reaction to goal changes. Update rules are used to handle goal instantiation and removal.

Given an observed agent state in a given time step, the likelihood of each goal can be determined from the observation, based on the goal distributions determined in the previous time step. This, in turn, allows the posterior probability of each goal to be updated at each time step.

The target acceleration profile relies on a decaying acceleration model since a constant acceleration model can be more accurate than constant velocity in the short term but less accurate in the long term. The likelihood of each goal and trajectory is estimated by comparing each trajectory with the observed agent state. Variations between predicted states and observed states are captured assuming a normal distribution on the position and velocity direction of the agent at a specific time. Trajectories with higher lateral accelerations are penalized. The Bayes rule is finally used to update the beliefs over the set of goals and trajectories by integrating the likelihood with the prior. Goals at different timesteps are matched by comparing the respective paths, and goal changes are modelled with a forgetting factor, balancing recent evidence and past evidence.

For example, the posterior may be smoothed at each time step with a uniform distribution as:

$$posterior = ( 1 - forgetting\_factor ) * posterior + forgetting\_factor * uniform .$$

The smoothed posterior is used as the new prior in the next time step. A forgetting factor of 0 means that posterior=prior from the previous time step. A forgetting factor of 1 means that the prior becomes uniform.

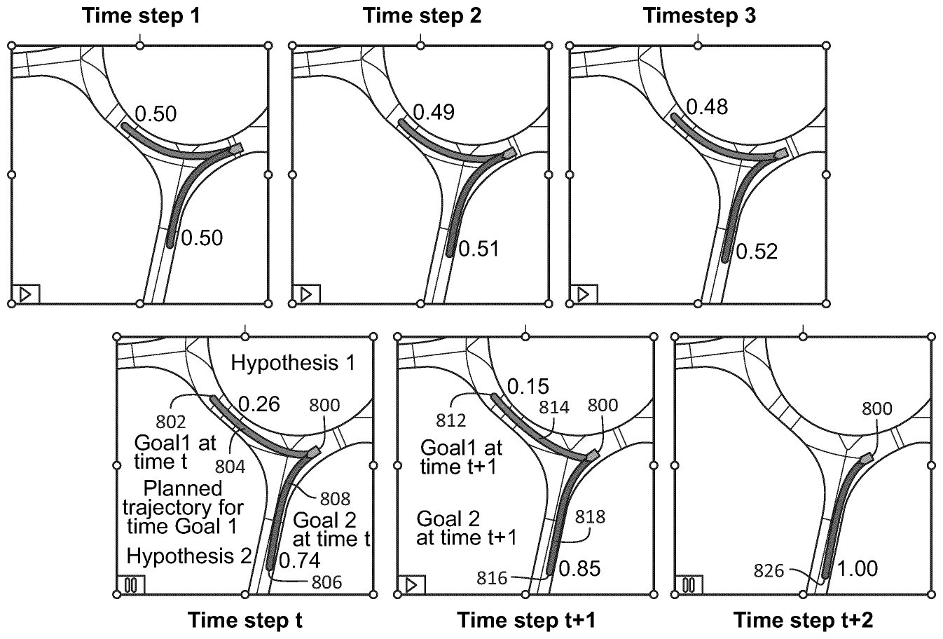

FIG. 8 shows a schematic plan view of a driving scene at incrementing time steps. A non-ego agent 800 is shown within a road layout and, at time t, first and second possible goals have been identified based on a search of a lane graph describing the topology of the road layout. The search of the lane graph is performed based on a location of the agent at time t. The goals are characterized by first and second goal locations 802, 806 within the road layout. First and second trajectories 804, 808 from the location of the agent 800 at time t to the first and second goal locations 802, 806 are computed, and used to determine respective goal probabilities for the first and second goals. Further details of the trajectory and probability computations are described below.

At time step t+1, the agent 800 has moved to a new location. A new search of the lane graph is performed based on the location of the agent at time t+1. That search returns third and fourth possible goals, characterized by third and fourth goal locations 812, 816 within the road layout. The third goal location 812 at time t+1 is near to the first goal location 808 at time t, and the third goal is matched to the first goal based on their respective sequences of lane identifier (recall that each goal is defined as a sequence of lane identifier's determined from the lane graph based on the agent's current position). The fourth goal location 816 at time t+1 is near to the second goal location 806 at time t, and the fourth goal is matched to the second goal based on their respective sequences of lane identifiers. Third and fourth trajectories 814, 818 from the location of the agent 800 at time t+1 to the third and fourth goal locations 812, 816 respectively are computed, and used to determine new goal probabilities for the third and fourth goals (matched to the first and second goals respectively).

At time step t+2, a further search of the lane graph is conducted based on the agent's location at t+2, returning only a single fifth goal, characterized by a fifth goal location 826 close to the fourth goal location 816 from time t+1, with a goal probability of 1, and which is matched to second goal.

Goals that are matched to each other may be associated with a common goal identifier. In the above example, this implies the first and third goals are each associated with a first goal identifier (Goal 1), and the second, fourth and fifth goals are each associated with a second goal identifier (Goal 2).

Certain highway layouts involve ramps, and ramps can have special connectivity and ad-hoc hypotheses can be used to predict agents on such on-ramps.

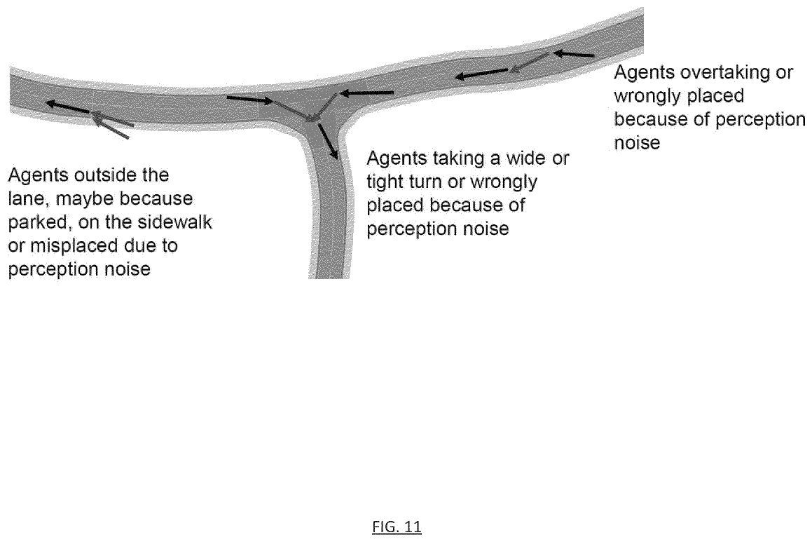

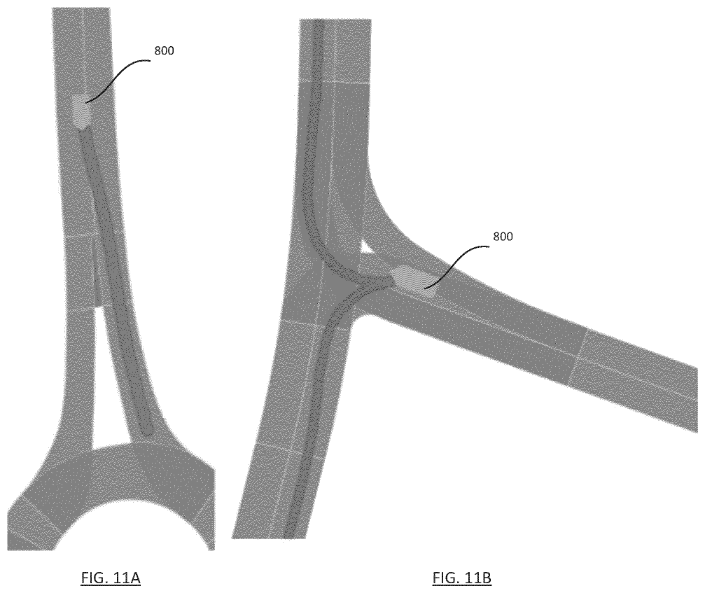

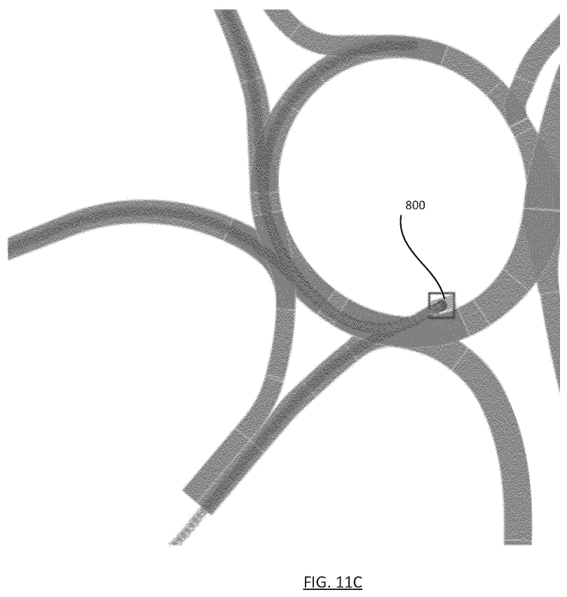

With oncoming lanes and junctions, it may be appropriate to reason about agents on a lane with direction incompatible with the agent direction of motion. In the example of FIG. 11, the agent might be positioned on the arrows and queried from there.

Further examples of somewhat more complex path and goal extraction scenarios are depicted in FIGS. 11A-C. Goals and target paths can nevertheless be extracted in these scenarios.

FIGS. 11A and 11B show two examples of path and goal extraction involving agents on the oncoming lane (FIG. 11A) near a roundabout (left-hand side driving) and (FIG. 11B) in an intersection along a given route (left-hand side driving). An agent might be located on the oncoming lane during an overtake or because of noise. Also, an agent in an intersection might take a tight or wide turn. Goals and paths can be extracted nonetheless.

To identify an oncoming side-lane (that with an incompatible side-lane direction on the other side of the road) into which a vehicle may proceed to its left/right from a given side-lane when heading in a given direction. This is used to explore the lane graph in all directions, for example when predicting an agent located on the oncoming lane and with an incompatible direction of motion, see examples in FIGS. 11A and 11B;

FIG. 11C shows a roundabout scenario, in which agents can be predicted even if outside the road layout because of perception noise or imprecise map annotations. Paths are extrapolated if the road layout is too short.

In this scenario, it is possible to obtain the side-lanes that are nearest (and equi-distant) to a given point if they match a set of flags. This is used to explore the lane graph starting from positions outside the road layout.

Further details of the inverse planning approach are described below. To provide relevant context, an example form of AV stack will now be described.

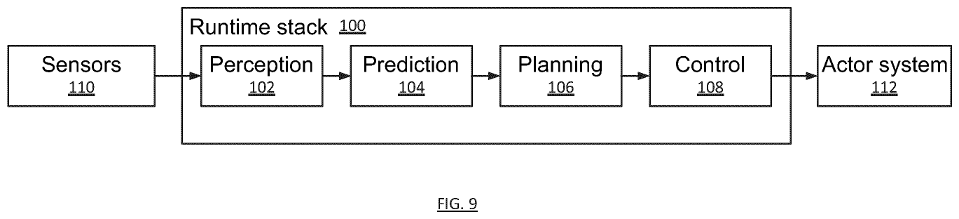

FIG. 9 shows a highly schematic block diagram of an AV runtime stack 100. The run time stack 100 is shown to comprise a perception (sub-) system 102, a prediction (sub-) system 104, a planning (sub-) system (planner) 106 and a control (sub-) system (controller) 108. As noted, the term (sub-) stack may also be used to describe the aforementioned components 102-108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

Note, there may be a distinction between a planned trajectory at a given time instant, and the actual trajectory followed by the ego agent. Planning systems typically operate over a sequence of planning steps, updating the planned trajectory at each planning step to account for any changes in the scenario since the previous planning step (or, more precisely, any changes that deviate from the predicted changes). The planning system 106 may reason into the future, such that the planned trajectory at each planning step extends beyond the next planning step.

Further implementation details of an illustrative embodiments will now be described.

The objective of motion prediction is to produce possible future trajectories and estimate how likely these are given the history of observations of the observable agents. A history hⁱ of k+1 observations for an agent i is defined as a sequence of coordinates (x, y), orientations θ, and velocity vectors

$$v ∈ {2}^{} : {h}^{i} = {[ ( {x}_{t}^{i} , {y}_{t}^{i} , {θ}_{t}^{i} , {v}_{t}^{i} ) ]}_{t = 0}^{k} ,$$

preceding and containing a current time step t=k. Similarly, a predicted trajectory is defined t=k++1 as ŷⁱ=[(\hat{x}ₜⁱ,ŷₜⁱ,\hat{θ}ₜⁱ,\hat{v}ₜⁱ)]ₜ₌ₖ₊₁^{T}

and a ground truth future trajectory is defined as

$${y}^{i} = {[ ( {x}_{t}^{i} , {y}_{t}^{i} , {θ}_{t}^{i} , {v}_{t}^{i} ) ]}_{t = k + 1}^{T} .$$

Each is defined up to a time horizon T. These trajectories can be decomposed into a path, which is a sequence of N positions [(xⁱ, y^{ī})]ₙ₌₀^{N}, and a motion profile, which is a sequence of speeds sⁱ=[sₜ^{l}]ₜ₌ₖ₊₁^{T} from which higher-order derivatives such as acceleration aₜⁱ and jerk jₜⁱ can be estimated. There are two challenges that a prediction system faces: the space of possible future trajectories is continuous, and the future is uncertain. The former challenge is handled by predicting a spatial uncertainty attached to the discrete predicted trajectories. This spatial uncertainty is modelled with a multivariate Gaussian capturing the position variance at each predicted future state. The latter challenge is addressed by producing a multimodal output, which is a discrete distribution over a set of predicted trajectories P (ŷⁱ).

### A. Overview

The proposed model performs multimodal prediction by taking a Bayesian inverse planning approach [13]; it recursively compares previously predicted trajectories with observations to estimate likelihoods and computes a joint posterior distribution over goals and trajectories using Bayesian inference. A system overview is shown in FIG. 1. As noted, the system involves four components described in more detail below: i.) goal and path extraction (1002), ii.) motion profile prediction (1004), iii.) trajectory generation (1006) and iv.) Bayesian inference (1010).

Likelihood estimation (1008) is also considered.

### B. Goal and Path Extraction

High-definition maps are useful in various aspects of self-driving; for example a map can help disambiguate the intentions of other agents [2], [15], and aid planning in challenging traffic situations [32]. The described embodiments utilize the OpenDrive standard with an additional layout definition for querying the geometry of roads and lanes, their properties, e.g. lane types, and how they are interconnected.

Given the position and orientation of an agent i at time t, the goal and path extraction component 1002 extracts a set of one or more possible goals gt for the agent by exploring all lane graph traversals up to a predefined depth. In highway situations, the immediate goals correspond to staying in the lane, or staying in the lane while maintaining the current lateral offset to the centre of the lane, or changing to a neighbour lane, or entering the highway if the agent is on the entry ramp, or exiting it if the agent is on the slow lane close to an exit ramp. This set of goals is referred to as the hypothesised goals.

A target path for a given goal is extracted based on the geometry of the road layout.

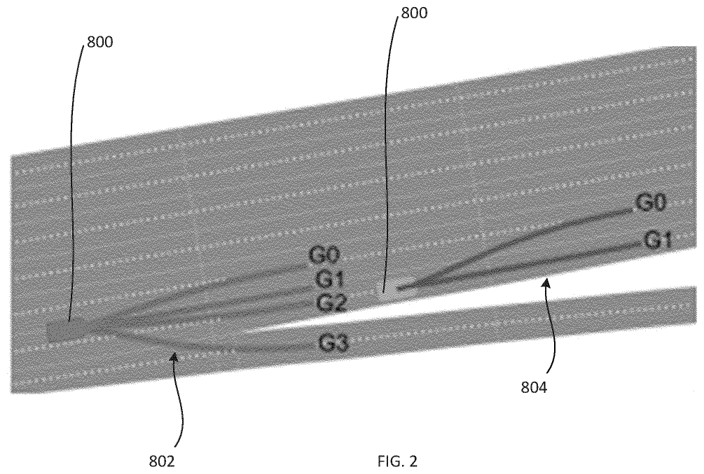

FIG. 2 illustrates the use of lane centre lines with an optional offset as target paths for trajectory generation. The goals correspond to intentions that an agent could have and the system 1000 multimodality derives from this set of possible intentions.

FIG. 2 shows a portion of an I-80 highway layout showing lane centre lines (dotted white lines) used as target paths for trajectory generation, annotated hypothesised goals and first and second sets of trajectories 802, 804 for a single agent 800 at first and second time steps respectively. The agent's hypothesised goals depend on the lane graph and its position on the road layout.

### C. Motion Profile Prediction

The predictive performance of different motion profile models varies strongly with the prediction horizon and traffic conditions, such as the congestion level [20]. A neural network-based approach for this task is used in order to capture more contextual variations and exploit the availability of training data [20]. In the present architecture, the motion profile prediction task is narrow and well-defined. In addition, the data is further split according to the behaviour being performed, e.g., follow-lane versus change lane, and context, e.g., number of front and side agents. These aspects permit the use of a mixture of experts collection of specialised and lightweight Mixture Density Networks (MDNs) [24], each focusing on a different subtask. Each expert model in the collection consumes a different sized 1D feature vector z. The features capture properties of the target agent being predicted as well as properties of front agents and side agents in the target agent's neighbourhood given the current state only. It is assumed the data has been filtered using an object tracker. The properties include agents' speeds, acceleration values, an agent class c, e.g. c ∈{car, truck, motorbike, . . . }. Follow-lane models include headway distances from the target vehicle. Change-lane models consume additional features such as the neighbouring side, if the side agents are in front or behind the target vehicle, the centre to centre distance to the target vehicle and the shortest distance between the vehicles' polygons and the target vehicle's polygon. The input for the change lane models contains only features of the agents on the neighbouring side that the change-lane is performed towards, i.e. left vs right. Highway entries and exits are considered change-lanes.

We have conducted experiments with agents within a 60 m radius as in [7], including up to 3 agents in front of target vehicle and up to 3 side agents on each side. Guided by the experiments, in one implementation, the collection of experts is made of 4 follow-lane models, each specialised for a different number of front agents, and 16 change-lane models, each specialised for a different number of front and side agents. At runtime, multiple models are selected based on the extracted goals, which can correspond to follow-lanes or change-lanes, and the number of surrounding agents. The neural networks' objective is to predict distances from current position over the next Ñ time steps, so the target is a sequence of distances yₜ₌₀^{d}=[rₜ]ₜ₌₁^{Ñ*}. The predicted sequence of distances is defined as ŷₜ₌₀^{d} Ñ is a function of horizon and delta time, respectively 5 seconds and 1 second in the illustrative examples below, hence 5. Each MDN model learns the joint distribution p(z,y^{d}) in the form of a multivariate Gaussian mixture model with M multivariate Gaussian functions:

$$p ( z , {y}^{d} ) = {\sum }_{m = 1}^{M} {π}_{m} 𝒩 ( z , {y}^{d} \vert {μ}_{m} , {\sum }_{m} ) , where \qquad ( 1 )$$

πₘ, μₘ and Σₘ are the probability, mean vector, and diagonal covariance matrix of the m^{th} multivariate Gaussian mixture component. MDNs also model uncertainty, predicting the mixture parameters including variances instead of single outputs. Each m component's prediction error is denoted as ∈ₘ and the model is trained with a Negative Log Likelihood (NLL) loss function:

$$NLL = - ln {\sum }_{m = 1}^{M} {π}_{m} {e}^{- \frac{1}{2} {ϵ}_{m}^{T} {\sum }_{m}^{- 1} {ϵ}_{m} - ln ( \sqrt{{( 2 π )}^{\tilde{N}} \vert {\sum }_{m} \vert} )} \qquad ( 2 )$$

To simplify the implementation, the integer M may be sent to 1. It was observed that the use of larger values did not impact the overall system performance. Indeed, the system relies on goal extraction and the collection of experts to handle multimodality. The component's vector of predicted means μₘ is used to construct a predicted motion profile ŝⁱ for an agent i given a known delta time, e.g. of 1 second.

In one example implementation, each MDN consists of 2 fully connected layers, 64 and 32 neurons each, with relu activations. Each model is trained independently on a specialised dataset split, augmented with samples from the other splits. For instance, follow-lane networks considering two front agents are trained with follow-lane samples with at least 2 front agents and, similarly, change-lane networks considering two side agents are trained with change-lane samples with at least 2 side agents. Hyper-parameters may be tuned using randomised search on the training set. Follow-lane networks are trained with a learning rate of 0.001 and a batch size of 1024 for 10 epochs. Change-lane networks are trained with the same learning rate and a batch size of 32 for 20 epochs.

As will be appreciated, the subject matter is not limited to the specific parameters/hyper-parameters of the preceding paragraph, and the details given therein are merely illustrative.

In an alternative implementation, the ensemble of expert networks is replaced with a single Graph Neural Network for motion profile prediction. This change is useful to handle non-highway settings like junctions and roundabouts in the motion profile prediction component of Flash.

One suitable network architecture is VectorNet, see https://arxiv.org/abs/2005.04259, which is incorporated herein by reference in its entirety. In the present context, the network architecture can be simplified by removing vectors and the need for any hierarchy.

The alternative architecture includes a Graph Attention Network followed by a Mixture Density layer for predicting future motion profiles with uncertainty. Attention coefficients can be inspected to investigate which agents matter for the prediction in different situations. Further details of the Graph Attention Network architecture may be found in https://arxiv.org/pdf/1710.10903.pdf and https://arxiv.org/abs/2105.14491, each of which is incorporated herein by reference in its entirety.

The input fully connected graph includes a node for each agent and each node is represented by hand-crafted features similar to those described above (orientation, velocity direction, speed, acceleration, dimensions, agent type). The spatial relationship between agents is captured by including positions among the node features and by fully connecting the nodes in the input graph. The graph is heterogeneous since the input feature for the agent being predicted includes its goal as a sequence of points (a coarse path) to allow conditioning the predicted motion profile over goals. Other agent features, such as agent distances, do not have to be provided, because they are implicit and can be inferred by the network itself.

The graph can be simplified by removing nodes of agents that are considered unimportant. For example, in a highway setting, only a selection of agents may be included, according to the same principles described above (e.g., only agents in the front and in the closest lanes on the sides, possibly a rear agent) instead of all agents in a distance. Limiting the agent context in this manner can help training and runtime.

VectorNet provides a suitable encoding for the road layout and agents. A Graph Attention Network introduces a greater level of flexibility.

Alternatively, VectorNet may be used in its original form, which would not necessarily require a Graph Attention Network.

### D. Pure Pursuit Trajectory Generator

Despite their strong ability to model context, neural networks are not interpretable and can perform poorly when conditions change [35], [36]. Pure pursuit is used to address these challenges and generate physically feasible trajectories describing how each agent might reach any of its hypothesised goals. Pure pursuit is a path tracking algorithm that uses a controller and a vehicle model to generate a trajectory that minimises error from the target motion profile and the target path. In the present implementation, the neural networks provide the target motion profile while the target path is extracted from the map as previously described. Intuitively, the path tracking approach imitates how humans drive; they look at a point they want to go to and control the car to reach it.

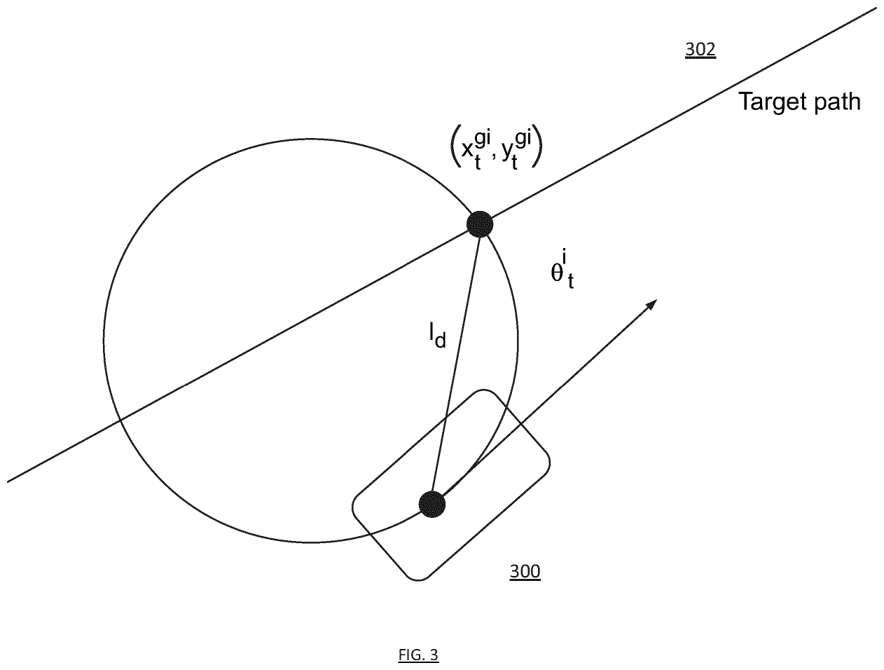

FIG. 3 shows a schematic view of an agent 300 and a target path 302.

As shown in FIG. 3, the algorithm chooses a goal position (xₜ^{g}, yₜ^{g}) using a lookahead distance parameter l_{d} and calculates the curvature that will move an agent from its current rear axle position to the target position while maintaining a fixed steering angle.

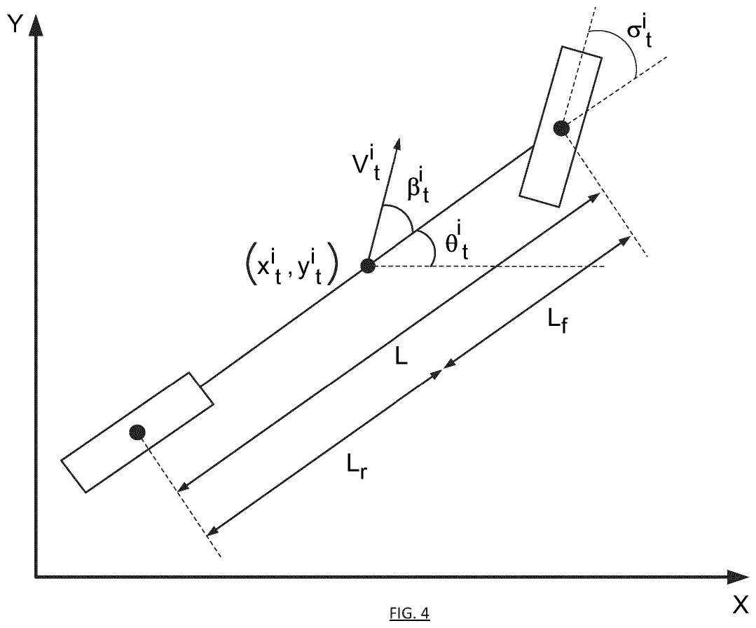

FIG. 4 shows a schematic view of an agent, annotated with parameters of a kinematic motion model describing motion of the agent.

By way of example, we fixed l_{d} to 10.0 m in our experiments. However, this parameter is configurable and different values could account for current speed or target path curvature. An agent's state at time t is described using a reference position, such as its centre (xₜⁱ, yₜⁱ), position current orientation θₜⁱ and speed sₜⁱ, With agents in the form of vehicles, one example of a suitable agent dynamic model to represent their motion is a kinematic bicycle model. In addition to the state of the vehicle, the bicycle model also requires the distance between the rear axle and the centre position Lᵣⁱ and the wheelbase length Lⁱ. Given a control input uₜⁱ=(aₜⁱ, σₜⁱ) at time t composed of acceleration and steering angle respectively, the Equation 3 and FIG. 4 describe the motion of the vehicle. A side slip angle

$${β}_{t}^{i} = {tan}^{- 1} ( \frac{{L}_{r}^{i}}{{L}^{i}} tan ( {σ}_{t}^{i} ) )$$

is computed given that the centre position of the agent is used. Finally, Δt represents the time difference between two time steps.

$$d = {s}_{t}^{i} Δ t + \frac{{a}_{t}^{i} Δ {t}^{2}}{2} \qquad ( 3 )$$

$${x}_{t + 1}^{i} = {x}_{t}^{i} + d cos ( {θ}_{t}^{i} + {β}_{t}^{i} )$$

$${y}_{t + 1}^{i} = {y}_{t}^{i} + d sin ( {θ}_{t}^{i} + {β}_{t}^{i} )$$

$${θ}_{t + 1}^{i} = {θ}_{t}^{i} + \frac{d}{L} cos ( {β}_{t}^{i} ) tan ( {σ}_{t}^{i} )$$

$${s}_{t + 1}^{i} = {s}_{t}^{i} + {a}_{t}^{i} Δ t$$

In the experiments detailed below, the control input uₜⁱ is calculated using a proportional controller with a gain kₚ=2 for both steer and acceleration components. The acceleration input at time t is the speed error to the future target speeds at t′=t+TΔt, where T=5 introduces an arbitrary delay. The final speed is used as target for the final tΔt of the prediction horizon. The target speeds are retrieved from the predicted motion profile ŝⁱ,

In the experiments, we predicted at 1 Hz and linearly interpolated at 10 Hz. Acceleration is capped acceleration using a maximum acceptable absolute acceleration maxₐ=6.0 m/s² and absolute jerk maxⱼ=10.0 m/s³ limits. Similarly, the orientation error is used for computing steering angle input. Orientation error θ_{∈t}ⁱ is the difference between the current vehicle orientation and the target orientation, i.e. the orientation the vehicle would have if it was pointing directly to the goal position on the path. A curvature of the circle that the vehicle would describe is computed as shown in Equation 4.

$$κ = 2 \frac{sin ( {{θ}_{ϵ t}}^{2} )}{{l}_{d}} \qquad ( 4 )$$

$${σ}_{t}^{i} = {tan}^{1} ( κ L )$$

### E. Bayesian Inference

The remaining characteristics of the system 100 are i.) processing the history of observations and ii.) performing multimodal trajectory prediction. The first of these is important since individual observations can be noisy, while the latter is necessary to handle the uncertainty due to the unknown intention of the target agent. Both are achieved by recursively consuming the observations in the history input and estimating the latent goal gₜⁱ ∈gₜⁱ of the target agent i via online Bayesian inference, see Equation 5. P(gₜ₌ₖ₋₁ⁱ|yₜ₌ₖ₋₁ⁱ) represents the previous posterior and is used as a prior in the current time step. At t=0 a uniform prior is Û(gₜ₌ₖ₋₁ⁱ)used.

$$\hat{P} ( {g}_{t = k}^{i} \vert {y}_{t = k}^{i} ) ∝ P ( {y}_{t = k}^{i} \vert {g}_{t = k - 1}^{i} ) P ( {g}_{t = k - 1}^{i} \vert {y}_{t = k - 1}^{i} ) \qquad ( 5 )$$

The present implementation relies on a single trajectory for a specific goal at a certain time step. The likelihood of each goal and its corresponding trajectory is estimated by comparing previously predicted trajectories ŷₜ₌ₖ₋₁ⁱ with the observed agent state at current time step t=k. A velocity direction ϕₜⁱ is extracted from velocity vector vₜⁱ components and use it in likelihood estimation. Variations between predicted states and observed states are captured assuming a normal distribution on the position and velocity direction of the agent at the current time step with fixed variances σ² for each term. We used the values σₓ=0.4, σ_{y}=0.4 and σ_{φ}=0.15 in the experiments detailed below.

$$P ( {y}_{t = k}^{i} \vert {g}_{t = k - 1}^{i} ) \approx 𝒩 ( {x}_{t = k}^{i} \vert {\hat{x}}_{t = k}^{i} , {σ}_{x}^{2} ) \cdot 𝒩 ( {y}_{t = k}^{i} \vert {\hat{y}}_{t = k}^{i} , {σ}_{y}^{2} ) \cdot 𝒩 ( {ϕ}_{t = k}^{i} \vert {\hat{ϕ}}_{t = k}^{i} , {σ}_{ϕ}^{2} ) \qquad ( 6 )$$

In certain situations, goals can only be reached if an agent executes an uncomfortable maneuver which should imply that those goals are less likely. To capture this aspect, trajectories with lateral absolute accelerations a i t above a predefined threshold maxₐ=0.0 are penalized proportionally to the amount of violation. This is integrated as a bias term. The probability of the corresponding goal is multiplied with a weight that is computed using the maximum lateral acceleration maxₐ^{g}^{ⁱ} of the trajectory and an exponential decay function. See Equation 7, where n is a normalisation factor and λ (e.g. λ=0.5) is the parameter that determines the amount of punishment. Lateral acceleration values are computed as

$${α}_{t}^{i} = \frac{{{v}_{t}^{i}}^{2}}{{r}_{t}^{i}}$$

where rⁱₜ is the radius of a circle that the vehicle is currently describing given its current steer angle and assuming a kinematic bicycle model.

$$\overline{P} ( {g}_{t = k}^{i} \vert {y}_{t = k}^{i} ) = η \hat{P} ( {g}_{t = k}^{i} \vert {y}_{t = k}^{i} ) \cdot {e}^{- λ ( {max}_{α}^{{g}^{i}} - {max}_{α} )} \qquad ( 7 )$$

An agent's goal may change in time. For example, one agent has finished a change-lane and wishes to perform a change-lane back in order to complete an overtake. Therefore, a forgetting step is added, which has the effect of smoothing the posterior, balancing recent evidence and past evidence. The output of the Bayes update is mixed with a uniform distribution to get the final posterior, see Equation 8, where the parameter γ (e.g. γ=0.1) determines the amount of smoothing.

$$P ( {g}_{t = k}^{i} \vert {y}_{t = k}^{i} ) = ( 1 - γ ) \overline{P} ( {g}_{t = k}^{i} \vert {y}_{t = k}^{i} ) + γ U ( {g}_{t = k}^{i} ) \qquad ( 8 )$$

Goals may change due to the agent motion through the layout, which will result in a change in the number of hypothesised goals. This is accounted for as follows. If a goal is no longer achievable, e.g. the agent has passed the exit ramp, then the goal is removed, and its probability mass is distributed equally among the remaining goals. Similarly, a new goal is added with mass equal to the value that it would have if a uniform distribution were defined over the complete set of hypothesised goals. This new mass

$$P ( {g}_{new} ) = \frac{1}{goals count}$$

is equally drawn from the masses of the other already existing goals. Otherwise, there is a 1:1 mapping between goals at t=k and those at t=k−1 and the map definition makes it straightforward to perform the matching.

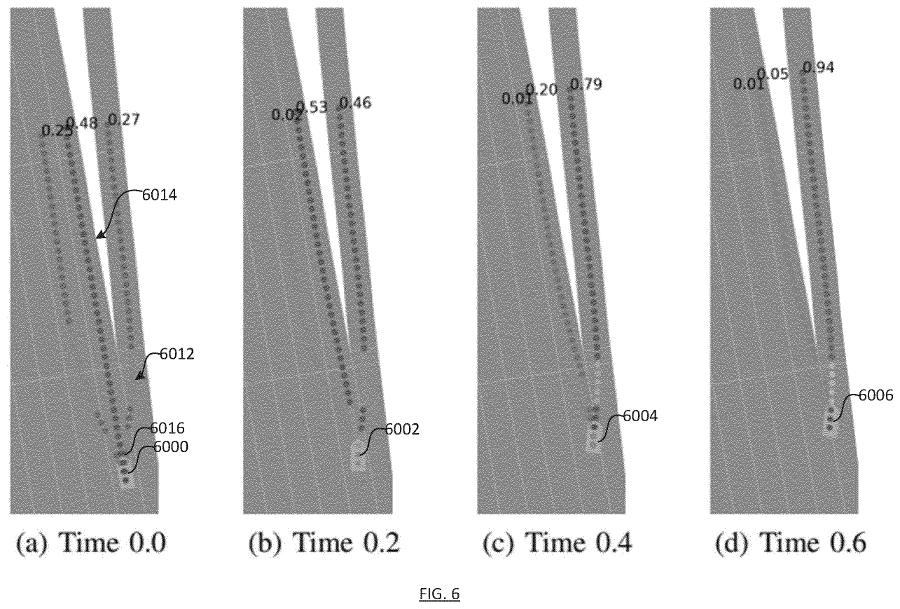

FIG. 6 shows a Bayesian inference component applied on a I-80 highway exit with a Δt=0.1 but showing images with a Δt=0.2. Boxes 6000, 6002, 6004, 6006 represents observed positions and orientations of a vehicle at sequential time steps. Predicted trajectories are shown as sequences of points starting from the vehicle, and these are annotated with their posterior probability. The shading of the points represents lateral acceleration. For example, points 6012, 6014 and 6016 have low (<2.0), medium (<5.0) and high (≥5.0) lateral acceleration respectively.

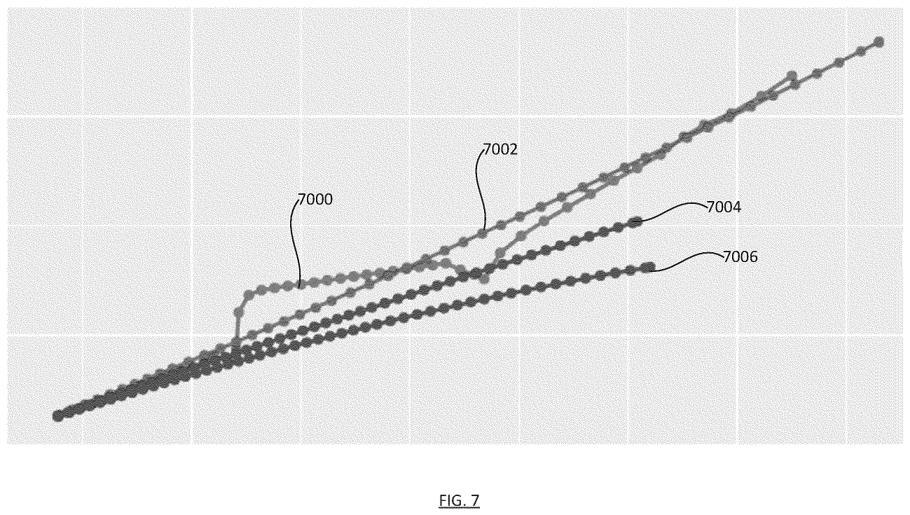

FIG. 7 shows example violations of kinematic and motion profile constraints. A ground truth trajectory 7000 presents high curvature and large variations in point distances. Predicted trajectories 7002 (most likely), 7004, 7006 are well-formed.

### G. Lateral Uncertainty Estimation

The prediction system can be configured to estimate a joint distribution over goals and trajectories while quantifying longitudinal uncertainty.

]In an optional extension, lateral uncertainty is modelled at each predicted timestep using standard deviations. It is assumed that lateral displacements are uncorrelated at each timestep index k and that they follow a discrete-time centered Gaussian distribution lₖ˜N(0, σₗ_{ₖ}). The parameter σₗ_{ₖ} is estimated empirically on the training set as follows:

$${σ}_{{l}_{k}} = \sqrt{\frac{{\sum }_{i} {( {e}_{k}^{i} - {\overline{e}}_{k} )}^{2}}{N}} , \qquad ( 9 )$$

where eₖⁱ is the lateral error for agent i at timestep index k, ēₖ is the mean lateral error at timestep index k, and Nis the number of dataset samples. We compute the lateral errors between the ground truth future positions Yⁱ and a predicted sequence of positions Ŷⁱ, given the predicted orientation \hat{θ}ₖⁱ. To estimating the lateral error without including errors introduced by the Bayesian inference, Ŷⁱ, is generated by combining the predicted motion profile with the path that is closest to the ground truth trajectory. Different errors are estimated for goals and trajectories corresponding to staying in the lane, staying in the lane while keeping a lateral offset and lane changes since they have different distributions.

### Motion Planning Application

The above examples consider a form of hybrid trajectory generation, using geometry-based path extraction and trajectory generation, but with the trajectory generator consuming a target motion profile generated in a data-driven fashion using a trained neural network. Whilst the previous examples focus on a motion prediction use case, the same form of hybrid trajectory generation can be used in the planner 106 to generate an ego trajectory given a defined goal. In that context, the goal of the ego agent is known (and assumed to be provided by a route planner or other goal generator), and the target path is extracted based on the road geometry and the known ego agent goal. A neural network is used in essentially the same way to generate a target motion profile for the ego agent, using an equivalent set of ego agent features. The target path and motion profile are provided to a classical trajectory generator in the same way, resulting in a generated ego trajectory that is fed to the controller 108.

Referring to FIG. 1, in a motion planning application, the goal and path extractor 1002 operates on the basis of a single known ego goal at a given time step (the ego goal is not extracted and only a single target path needs to be extracted from the map based on the ego goal). The motion profile predictor 1004 operates in the same way, but as an ego motion profile generator, and sits within the planner 106 along with the trajectory generator 1006, whose role is now to generate an ego trajectory to pass to the controller 108 to implement.

### Scenario Query Engine

High-definition maps are useful in various aspects of self-driving; for example a map can help disambiguate the intentions of other agents and aid planning in challenging traffic situations. A scenario query engine is provided for querying the geometry of roads and lanes, their properties, e.g. lane types, and how they are interconnected. As noted, given an orientation of an agent i at time t, its possible goals and paths can be extracted using the scenario query engine by exploring all lane graph traversals up to a depth. For example, the graph of lanes may be explored using a depth-first search algorithm. The depth value can be an expected travelled distance derived from prediction horizon and estimated future speeds or a larger value. A breadth-first search could be used as an alternative. While exploring the graph of lanes, lane midlines can be extracted and cropped to identify goals and build paths for the subsequent trajectory generation step. In highway situations, the goals and respective paths correspond to staying in the lane, entering the highway or exiting it. In multiple lane situations, they include changing to a neighbour lane. Near or inside roundabout and intersections, they correspond to exits, based on the available lane connections.

The described scenario query engine (SQE) allows efficient geometric and topological querying of a static road layout. The static road layout may for example be formulated in OpenDRIVE or some other schema. Both geometric and topological queries return results in a form that can be interpreted in the context of the original road layout description. OpenDRIVE is intended to be mainly optimized for processing “on the wire”. To a degree, the schema seeks to avoid duplication of information (although this is by no means a hard-and-fast rule). All-in-all, the construction of the OpenDRIVE schema is not well-suited to certain forms of querying, rendering certain applications of OpenDRIVE seemingly impractical. The SQE addresses these issues as described below, which opens up new practical applications of OpenDRIVE and similar schemas.

Goal discovery utilises the following queries to the SQE:

GetSideLanesCoveringPointIf: Get the side-lanes that cover a given point if they match a set of flags, e.g. driving or biking lane types;

GetSideLanesIntersectingBoxIf: Get the side-lanes that intersect an axis-aligned box if they match a set of flags. This query is used to retrieve lanes in a region instead of just a point. In general, querying a region is sensible since agents have non-zero dimension and because of spatial uncertainty. (Axis-aligned means aligned with respect to the x and y axis. Queries based on simple axis-aligned boxes are more efficient than queries based on rotated boxes or more complex polygons, although the use of more complex queries is not excluded)

GetNeighbouringDirectedSideLanesOfDirectedSideLaneIf: Get the side-lanes into which a vehicle can proceed sideways (laterally) from a given side-lane when heading in a given direction (described relative to the direction in which the if, and only if, they match a set of flags. This is used to explore neighbouring lanes when predicting lane changes, see examples in FIG. 2;

GetOnwardDirectedSideLanesOfDirectedSideLane: Get the side-lanes into which a vehicle may proceed onwards (longitudinally) from a given side-lane when heading in a given direction. This is used to explore the lane graph in the depth-first search;

GetMidLineForDirectedSideLane: Get a line-string that describes the mid-line of the given side-lane in the map frame (the frame that OpenDrive refers to as the inertial frame). The line-string is ordered in the specified direction. This is used to build the path for trajectory generation;

GetOncomingDirectedSideLaneOn {Left/Right} SideOfDirectedSideLane: Get the oncoming side-lane (that with an incompatible side-lane direction on the other side of the road) into which a vehicle may proceed to its left/right from a given side-lane when heading in a given direction. This is used to explore the lane graph in all directions, for example when predicting an agent located on the oncoming lane and with an incompatible direction of motion, see examples in FIGS. 11A and 11B;

GetSideLanesNearestToPointIf: Get the side-lanes that are nearest (and equidistant) to a given point if they match a set of flags. This is used to explore the lane graph starting from positions outside the road layout, see example in FIG. 11C.

The described techniques have both “online” and “offline” applications in autonomous driving. In the present context the SQE supports inverse planning prediction in an online or offline context.

An online (or “runtime”) application refers to an implementation within an autonomous vehicle stack to support autonomous planning or other decision-making functions (such as motion planning, motion prediction, route planning etc.). In an online context, a planner is required to plan driving actions for a given scenario, responding to changes in the scenario in real-time.

An offline application refers to other forms of applications, for example as part of a set of tools to support the development, testing and/or training of AV systems.

Whether real or simulated, a scenario requires an ego agent to navigate a real or modelled physical context. The ego agent is a real or simulated mobile robot that moves under the control of the stack under testing. The physical context includes static and/or dynamic element(s) that the stack under testing is required to respond to effectively. For example, the mobile robot may be a fully or semi-autonomous vehicle under the control of the stack (the ego vehicle). The physical context may comprise a static road layout and a given set of environmental conditions (e.g. weather, time of day, lighting conditions, humidity, pollution/particulate level etc.) that could be maintained or varied as the scenario progresses. A dynamic scenario additionally includes one or more other agents (“external” agent(s), e.g. other vehicles, pedestrians, cyclists, animals etc.).

In an offline simulation context, a scenario description is provided to an offline simulator as input, in order to expose a stack under testing to a simulated scenario. In an online context, a perception system may be used to generate a scenario description that can be used as a basis for higher-level functions, such as motion prediction and planning, which might involve some form of online simulation to simulate possible futures and plan accordingly.

A scenario description may be encoded using a scenario description language (SDL), or in any other form that can be consumed by whichever component(s) require it. As briefly discussed, the ASAM OpenDRIVE (R) standard defines a storage format for the static description of road networks and OpenSCENARIO (R) may be used to add dynamic content. Other forms of scenario description may be used, including bespoke languages and formats, and the present techniques are not limited to any particular SDL, storage format, schema or standard.

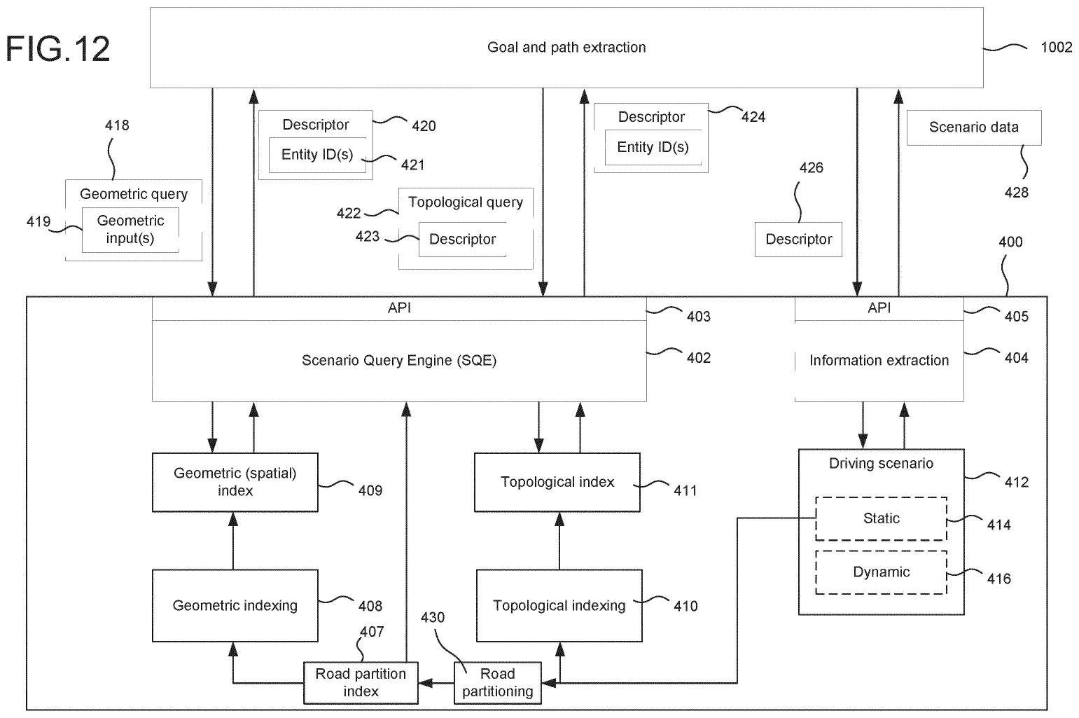

FIG. 12 shows a schematic block diagram of a scenario access system 400. The scenario access system 400 facilitates a lane graph search on a scenario description 412 (map), as a basis for goal extraction in inverse planning.

The scenario description 412 is shown to have both static and dynamic layers 414, 416. In this example, the static layer 414 is encoded in a specification (document) that conforms to the OpenDRIVE schema, or some variant of OpenDRIVE (or other structured scenario description format), and the dynamic layer 416 is encoded using OpenSCENARIO.

The scenario access system is shown to comprise a scenario query engine (SQE) 402 and an extraction component 404. The SQE 402 is called via a first application programming interface (403) and the information extraction component 404 is called via a second API 405.

The first API 403 provides a set of scenario query functions that can be flexibly combined to perform complex queries on the driving scenario 412, and the second API 405 provides a set of information extraction functions for selectively extracting information from the driving scenario 412. The goal and path extraction component 1002 of FIG. 1 is depicted with access to the APIs 403, 405.

The SQE 402 accepts both “geometric” and “topological” queries on the scenario description 412. Various scenario query functions provide results in the form of “descriptors” that allow information to be located in the underlying scenario description 412. The following examples consider geometric and topological queries on the static layer 414.

A geometric query 418 indicates one or more geometric constraints 419 (geometric inputs), and returns a response 420 in the form of a descriptor that identifies one or more road structure elements that satisfy the geometric constraints 419.

A descriptor comprises an identifier of each road structure entity that allows the corresponding section of the static layer 412 (that is, the section describing that road structure element) to be located (denoted by reference numeral 421 for the descriptor 420). A descriptor may contain additional information about the road structure element(s) satisfying the query. For example, the geometric inputs 419 might define a point or box (rectangle), and the response might indicate any road structure element(s) that intersect that point or box.

To facilitate geometric queries, a geometric indexing component 408 is provided. The geometric indexing component 408 builds a geometric (spatial) index 409 of the static layer 414 of the scenario description 412. The geometric index 409 is an in-memory data structure that maps geometric inputs to corresponding road structure elements within the scenario description 412. In the following examples, “roads” and “lanes” are the main types of road element considered. As described in further detail below, in OpenDRIVE, roads are described in terms of <road>elements and lanes are described in terms of <lane>elements. Although a single geometric index 409 is depicted, separate geometric indexes may be provided for different types of road structure element, for example separate spatial indexes for road and lanes.

To support efficient geometric querying, novel “road part” and “lane part” concepts are introduced. These concepts and their manner of utilization are described in Table 1 below.

The geometric index 409 is two-dimensional (2D), defined in a birds-eye-view plane of the road network. The static layer 414 may be 3D (e.g. to describe varying road elevation), even when the geometric index 409 is 2D. In other implementations, the geometric index 409 is three dimensional. Three-dimensional spatial indices may be useful e.g. in addressing ambiguity inherent in a plan view associated with under/over passes (where one road passes under another, leading to ambiguity in a 2D plan view).

Whilst the geometric index 409 is depicted as a single element in FIG. 12, in the described implementations, the API 403 is supported by a collection of geometric indexes, namely a bounding box tree, an inner boundary line segment tree and an outer boundary line segment tree.

A topological query 422 includes an input descriptor 423 of one or more road structure elements (input elements), and returns a response in the form of an output descriptor 424 of one or more road structure elements (output elements) that satisfy the topological query because they have some defined topological relationship to the input elements. For example, a topological query might indicate a start lane and destination lane, and request a set of “micro routes” from the start lane to the destination lane, where a micro route is defined as a sequence of traversable lanes from the former to the latter. This is an example of what is referred to herein as “microplanning” (see FIG. 6 for further details). Different topological query types may be defined for different types of topological relationships.

To facilitate topological queries, a topological indexing component 410 builds a topological index 411 of the static layer 414 in the form of a lane graph. The topological index 411 is an in-memory graph of side-lanes. Nodes of the graph encode structure elements and edges of the graph represent code topological relationships between the side-lanes. The nodes are embodied in memory as addressable memory locations and the edges as in-memory points to the corresponding memory addresses.

The second API 426 maps information provided in a descriptor 426 to the corresponding section(s) of the scenario description 412. In response to a descriptor 426 of the static layer 416, the information extraction component 404 provides one or more pieces of scenario data 428 extracted from the corresponding section(s) of the static layer 414. For example, given a descriptor 426 indicating a particular lane, the information extraction component 404 would be able to provide, say, the 3D geometry of the lane from the static layer 414 or some associated piece of information from the dynamic layer 416 (e.g. indicating any agents whose starting locations lie within a particular road or lane).

Geometric and topological queries can be flexibility combined. For example, starting with some geometric constraint(s), a geometric query can return the description of corresponding road(s) or lane(s) (e.g. to find the lane containing the point x). The latter can then be used as the basis for a topological query (e.g. to find all lanes connected to the lane containing the point x).

Both geometric and topological queries return results in a form that can be interpreted in the context of the original static layer 414. A descriptor 420 returned on a geometric query 418 maps directly to the corresponding section(s) in the static layer 414 (e.g. a query for the lane intersecting the point x would return a descriptor that maps directly to the section describing the lane in question). The same is true of topological queries.

Whilst FIG. 12 depicts a driving scenario 412 with both static and dynamic layers 416, the techniques can be applied to a description of a static road layout with no dynamic layer, such as a high-definition road map use din navigation and prediction/planning.

A road partition index 407 is also shown, which is generated by a road indexing component 432 and is described in detail below. The road partition index 407 is used to build the geometric index 408, and also to support certain modes of query directly at the SQE API 403. The road indexing component 432 is supported by a road partitioning component 430 that partitions the road into road parts.

Certain novel concepts underpinning geometric queries within the SQE 402 are summarized in Table 1 below. The concepts are not found in the OpenDRIVE schema, and have been introduced to allow geometric queries to be constructed so that they can be processed quickly.

Table 2 summarizes the construction of the various indexes shown in FIGS. 4 and 4A.

Table 3 summarizes how these indexes are used to support certain modes of query at the SQE API 403.

Tables 1 to 3 refer to certain OpenDRIVE concepts, and further description of these OpenDRIVE concepts follows Table 3. Whilst OpenDRIVE is used as a reference point, the described techniques can be applied to other road network schemas, with the same benefits as set out herein.

TABLE 1
Summary of additional concepts.

| Concept | Description |
|---|---|
| Road part. | Applicable to road network schemas, such as OpenDRIVE, |
| | in which road/lane boundaries are encoded in terms of |
| | multiple functions that can change at arbitrary points |
| | along the road. The number of functions may also change |
| | e.g. as the number of lanes changes. A road part refers to |
| | an s-coordinate interval in which the road is described by |
| | a single fixed subset of the functions of interest. In other |
| | words, within any given road part no change occurs in any |
| | of the functions of interest along the length of the road part |
| | (and the number of functions does not change). |
| | For example, a road reference line might be defined as a |
| | straight line function (f1) on the interval [0, s2) (its |
| | support), a spiral function (f2) on the interval [s2, s3) and |
| | an arc function (f3) on the interval [s3, s5]. The interval [0, |
| | s1) could span a first lane section with a single side-lane |
| | (ID 1) of constant width (constant width function f4). At |
| | s1, a new lane section might begin with two side-lanes (ID |
| | 1 and 2), with the width of Lane 2 described by a function |
| | f5 linearly increasing from zero in the interval [s1, s4), and |
| | then by a constant width function f6 in the interval [s4, s5]. |
| | For simplicity of illustration, it is assumed that the width of |
| | Lane 1 remains constant throughout, described by f4. In |
| | this case, one viable partitioning of the road that satisfies |
| | the above requirements is: |
| | ([0, s1), [s1, s2), [s2, s3), [s3, s4), [s4, s5]). |
| Lane part. | A lane part refers to a side-lane within a road part in the |
| | above sense (an s-interval in which no function of interest |
| | changes and the number of functions does not change). |
| | A lane part may be described by a “bundle” comprising a |
| | road partition identifier (e.g. s-rage of the partition) and a |
| | lane ID. |
| | So, in the above example, there are nine lane parts in total - |
| | a single lane part being the lane with ID 1 in the interval [0, |
| | s1), with two lane parts in each of the subsequent intervals |
| | being the portions of the lanes with ID 1 and 2 respectively |
| | contained within that interval. Note the partitioning of the |
| | lanes is defined by the partitioning of the road as a whole, |
| | which in turn is defined by the supports of the full set of |
| | functions of interest. |

TABLE 2
Summary of indexes.

| Index | Description | |
|---|---|---|
| Topological | A directed graph (side-lane graph) in which nodes | |
| index 411. | represent side-lanes and edges between nodes represent | |
| | directed lane connections between side-lanes (which may | |
| | or may not be drivable; e.g. it may be useful to find a | |
| | sequence of side-lanes navigable by pedestrians). In this | |
| | context, the term “lane change” is used in a broader sense, | |
| | and can include not only left/right lane changes, but also | |
| | “onward” lane changes from one lane to its immediate | |
| | successor/predecessor (staying in lane from the driver's | |
| | perspective, whilst crossing a boundary between | |
| | connected roads/junctions/lane sections etc. of the road | |
| | network). The existence of a path through the graph from | |
| | a first node to a second node implies the existence of a | |
| | drivable route from the former to the latter, expressed as | |
| | the corresponding sequence of side-lanes (micro-route) to | |
| | be driven by a vehicle. | |
| | Each edge may be associated with a cost that is | |
| | representative of driving distance incurred by the | |
| | corresponding lane change. For a left/right lane change, | |
| | the cost would generally depend on lateral distance from a | |
| | current lane to its left/right neighbour. For an onward lane | |
| | change from a current lane to an onward lane, the cost | |
| | would generally depend on the length (longitudinal | |
| | extent) of the current lane (which would have to be driven | |
| | to reach the onward lane). | |
| | By and large, there is a one-to-one mapping between | |
| | nodes in the topological index and side-lanes in the | |
| | underlying OpenDRIVE layout, which is desirable to | |
| | maintain a close alignment with the underlying road | |
| | network representation. Bi-directional side-lanes are an | |
| | exception to this one-to-one mapping: a bi-directional | |
| | lane is represented as two separate nodes in the | |
| | topological index, one for each driving direction. | |
| | In the described implementations, the topological index | |
| | does not leverage the road part and lane part concepts | |
| | introduced above; rather, these are only utilized in the | |
| | construction and processing of geometric queries. | |
| Road | Addresses schemas, such as OpenDRIVE, in which | |
| partition | road/lane boundaries are encoded in terms of multiple | |
| index 407. | functions that can change at arbitrary points along the | |
| | road. The number of functions may also change e.g. as the | |
| | number of lanes changes. To build a road partition index, | |
| | a road is partitioned, as set out above, based on the | |
| | supports of the multiple functions of interest, such that | |
| | each road part is described by a single fixed subset of the | |
| | functions of interest. In other words, each road part is | |
| | chosen such that no change occurs in any of the | |
| | functions of interest along the length of the road part (and | |
| | the number of functions does not change). The road | |
| | partition index has an entry for each road part, which in | |
| | turn contains reference(s) to the subset of the functions of | |
| | interest that describe that road part. | |
| | Taking the above example, suppose the functions of | |
| | interest are those describing the road reference line and | |
| | the functions describing the lane widths (this is a | |
| | simplified example for the sake of illustration). In that | |
| | case, one viable construction of the road partition index | |
| | is: | |
| | [0, s1): (Ref_f1, Ref_f4) | |
| | [s1, s2): (Ref_f1, Ref_f4, Ref_f5) | //no. of lanes |
| | | increases. |
| | [s2, s3): (Ref_f2, Ref_f4, Ref_f5) | //road ref. line fn. |
| | to f2. | changes |
| | [s3, s4): (Ref_f3, Ref_f4, Ref_f5) | //road ref. line fn. |
| | to f3. | changes |
| | [s4, s5]: (Ref_f3, Ref_f4, Ref_f6) | //Lane 2 width fn. |
| | to f6. | changes |

| | |
|---|---|
| | Computation of the lane boundaries requires the road |
| | reference line and the lane width functions (the lane width |
| | function for Lane 1 defines its geometry relative to the |
| | road reference line; the lane width function for Lane 2, in |
| | turn, defines the geometry of Lane 2 relative to that of |
| | Lane 1). In the above example, it is guaranteed that the |
| | full set of lane boundaries can be computed for any given |
| | road part with a single subset of functions. |
| | The road partition index provides extremely fast |
| | processing of queries on specified road parts. Such a |
| | query might contain an identifier of a road part (e.g. its s- |
| | interval) or a bundle describing a lane part (lane ID, road |
| | part ID) and ask for, say, the (s, t) coordinates on the road |
| | of a given (x, y) point, the closest point on a lane mid-line |
| | to a given (x, y) point, or to determine whether a point or |
| | box is contained within a given road or lane part. Such |
| | queries on the road partition index could be “internal” |
| | (see e.g. “containment queries” below) or “external” |
| | (meaning that the information identifying the road or |
| | lane part is provided at the SQE API). |
| | Only a single set of functions is needed to answer such |
| | queries, namely the subset of functions referenced in the |
| | corresponding entry of the road partition index. The query |
| | can be answered quickly, because it is guaranteed by |
| | design that the subset of functions needed to do so will |
| | not change within the partition in question. |
| Bounding | A spatial (geometric index) that can be used, among other |
| box tree | things, to support fast “containment” queries (e.g. a query |
| 450. | that provides a point or box, and asks for all side-lane(s) |
| | intersecting the point/box). Each leaf node contains a |
| | bounding box of a lane part (a lane or lane portion within |
| | a road part) and a bundle uniquely identifying the lane |
| | part, namely a lane ID, and some reference to the entry in |
| | the road partition index for the corresponding road part |
| | (e.g. the s-coordinate interval for the road part or some |
| | other identifier of the road part that can be used to locate |
| | the entry in the road partition index). |
| | The “internal” parent/child structure of the tree is not |
| | required to have any specific correspondence to the road |
| | structure, in that leaf nodes can be grouped in any way to |
| | support fast queries (which would typically mean |
| | grouping together nearby boxes). A self-balancing tree |
| | may be used that adapts parent/child relationships |
| | dynamically. |
| | The road partition index is used to build the bounding box |
| | tree. Recall that each leaf node corresponds to a single |
| | lane part. In order to compute the bounding box of the |
| | leaf node, the geometry of the lane part is first computed |
| | using the single set of fixed functions referenced in the |
| | road partition index. It is then straightforward to compute |
| | bounding box coordinates for the lane part in question. |
| | The leaf node is populated with the bounding box |
| | coordinates, and a bundle comprising the lane ID and a |
| | reference to the corresponding road part in the road |
| | partition index. |
| Line | A spatial (geometric index) that can be used, among other |
| segment | things, to support fast “distance” queries (e.g. a query that |
| tree(s) | provides a point for the closest side-lane(s) to the point). |
| 452a, | Each leaf node contains a straight line segment that |
| 452b. | approximates a boundary on a given interval, which is |
| | fully contained within a single road part (that is, no line |
| | segment crosses the boundary between different road |
| | parts). In the described implementation, each line segment |
| | is computed for a single boundary within a sub-interval of |
| | a given road part, where the size of the sub-interval |
| | decreases with road/lane curvature to maintain a certain |
| | level of accuracy in the line segment approximation. Each |
| | leaf node also contains a bundle describing the lane part |
| | to which it belongs (which may result in significant |
| | duplication of references across the leaf nodes of the tree, |
| | particularly with narrow sub intervals). |
| | In the described implementation, two separate line |
| | segment trees are built on inner and outer boundaries |
| | respectively. Within a road, most lines serve as both inner |
| | and outer boundaries - e.g. in a road with Lanes 1 and 2, |
| | the outer boundary of Lane 1 is the inner boundary of |
| | Lane 2. The outer boundary of the outermost lane is not |
| | an inner boundary. In a two-way road, the boundary |
| | between Lane 1 and Lane −1 is not an outer boundary, but |
| | is the inner boundary to both Lane 1 and Lane −1, and its |
| | line segments are indexed twice in the inner boundary tree |
| | 452b (in association with Lane 1 and Lane −1 |
| | respectively). |
| | In the inner boundary tree 452a, each leaf node contains a |
| | line segment, a bundle describing the lane part of which |
| | that line segment is an inner boundary. In the outer |
| | boundary tree 452b, each leaf node contains a line |
| | segment, a bundle describing the lane part of which that |
| | line segment is an outer boundary. A given line segment |
| | may appear in both trees, but with different lane IDs and |
| | flags. |
| | Each direct parent node of a set of leaf nodes contains a |
| | bounding box around all line segments of its child nodes, |
| | and each parent of non-leaf nodes contains a bounding |
| | box around the bounding boxes of children. |
| | The “internal” parent/child structure of the tree is not |
| | required to have any specific correspondence to the road |
| | structure, in that leaf nodes can be grouped in any way to |
| | support fast queries (which would typically mean |
| | grouping together nearby line segments at the leaf level, |
| | and near boxes higher up the tree). Line segments from |
| | different road parts may therefore be grouped together |
| | under the same direct parent. A self-balancing tree may be |
| | used that adapts parent/child relationships dynamically. |
| | The road partition index is used to build the bounding box |
| | tree. Recall that each leaf node corresponds to a line |
| | segment contained within a single road part. The line |
| | segment is computed using the single set of fixed |
| | functions referenced in the road partition index. It is then |
| | straightforward to compute bounding box coordinates for |
| | all line segments under a common parent node, and to |
| | compute bounding boxes for parent nodes higher up the |
| | tree. |

TABLE 3
Summary of example query modes.

| | Supporting | |
|---|---|---|
| Query mode | indexes | Description |
| Containment. | Bounding | A containment query is answered in two |
| | box tree | phases. The box tree is first used to obtain |
| | (phase 1); | a set of candidate lane part(s), whose |
| | Road | bounding box(es) intersect the point/box in |
| | partition | question. This is not definitive, as a |
| | index | bounding box for a given lane part will, in |
| | (phase 2) | most cases, span one or more regions |
| | | outside of the lane part. The second phase |
| | | of the query uses the road partition index to |
| | | answer the query definitively. Recall that |
| | | each leaf node contains the bundle for the |
| | | lane part in question. This, in turn, allows |
| | | the required functions to be retrieved using |
| | | the road partition index (an “internal” query |
| | | on the road partition index, triggered by the |
| | | containment query). By design, this is a |
| | | single set of functions that does not change |
| | | within the road/lane part. Using this single |
| | | set of functions, the required geometry of |
| | | each candidate lane part can be computed to |
| | | any desired accuracy, and used to answer |
| | | the query in respect of that lane part |
| | | definitively. |
| | | The response to a containment query |
| | | provides the bundle(s) describing the lane |
| | | part (or each lane part) satisfying the query. |
| | | The bundle can, in turn, be used in a further |
| | | external query pertaining to the road/lane |
| | | geometry on the road partition index (see |
| | | “road partition queries” below) |
| | | A containment query returns a null response |
| | | if the point/box does not intersect any side- |
| | | lane. A containment query may also be |
| | | type-specific, in which case a null response |
| | | is returned if the point/box is not contained |
| | | within any side-line of the specified type |
| | | (even if it is contained within a side-lane of |
| | | some other type). |
| Distance. | Line | A distance query asks for the closest side- |
| | segment | lane to a given (x, y) point or box. A |
| | tree(s). | distance query may be type-specific, and ask |
| | | for the closest side-lane of a type specified |
| | | by a set of query flag(s). |
| | | In general, one has to find both the nearest |
| | | inner and outer boundary and then chose |
| | | that which is closest (assuming that the |
| | | query point is not covered by the relevant |
| | | sub-set of side-lanes). |
| | | In the specific case of a distance query that |
| | | is not type-specific, the SQE 402 assumes |
| | | the given point (or box) is not contained in |
| | | any side-lane, and therefore lies outside the |
| | | boundaries of the road. In this case, it is |
| | | sufficient to find the closest outer boundary |
| | | line segment to (x, y) via a search on the |
| | | outer boundary tree only. Therefore, before |
| | | making the distance query, generally a non- |
| | | type-specific containment query should be |
| | | run (unless it is already known that the point |
| | | (x, y) lies outside of the road boundaries), |
| | | and the distance query should only be run if |
| | | the containment query returns a null result. |
| | | To respond to a type-specific distance |
| | | query, similar principles apply, in so far as |
| | | the SQE assumes the point (x, y) (or box) is |
| | | not contained in a side-lane of the specified |
| | | type, although a search is required on both |
| | | trees (see above). Therefore, generally |
| | | speaking, a type-specific containment query |
| | | should be run first, and the type-specific |
| | | distance query should only be run if this |
| | | returns a null result. |
| | | Geometric rules are constructed for |
| | | identifying viable branches of a line |
| | | segment tree based on parent bounding |
| | | boxes. Given a set of parent bounding boxes |
| | | at a particular level in the tree, it is generally |
| | | possible to exclude most of these, on the |
| | | basis that they could not possibly contain |
| | | the closest line segment to the point (x, y). |
| | | The above assumptions leverage the |
| | | respective benefits of the box tree and the |
| | | line segment tree(s). A containment query |
| | | can be answered more efficiently with a |
| | | search on the box tree, whereas a distance |
| | | query can be answered efficiently on the |
| | | line segment(s) in the case that lack-of |
| | | containment does not need to be verified. |
| | | Of course, distance and containment could |
| | | be contained in a single API query. Such a |
| | | query would be answered first with a search |
| | | on the containment tree and road partition |
| | | index to ascertain containment (type- |
| | | specific or non-type specific), in the same |
| | | way as a containment query,followed by a |
| | | search on the line segment tree(s) in the |
| | | case of a null containment result. |
| | | The response to a distance query provides |
| | | the bundle(s) describing the lane part (or |
| | | each lane part) satisfying the query. The |
| | | bundle can, in turn, be used in a further |
| | | query pertaining to the road/lane geometry |
| | | on the road partition index (see “road |
| | | partition queries” below). |
| Road | Road | A broad class of query that can be answered |
| partition. | partition | from the road partition index directly. A |
| | index. | “road partition query” contains an identifier |
| | | of a road part (e.g. s-interval) or a bundle |
| | | describing a lane part (lane ID, road part |
| | | ID). Typically, this information would be |
| | | obtained via an earlier containment or |
| | | distance query. These are “external” queries |
| | | on the road partition index, in that the |
| | | road/lane part in question is specified in a |
| | | query at the API (in contrast to the internal |
| | | query on the road partition index in the |
| | | second phase of responding to a |
| | | containment query). |
| | | Examples include a query to to find |
| | | corresponding (s, t) coordinates in a |
| | | specified road part of a given (x, y) point, to |
| | | find the closest point to (x, y) on the midline |
| | | of the lane part etc.), again leveraging the |
| | | performance benefits of the road partition |
| | | index. |
| Route | Topological | A query that returns a micro-route from a |
| planning. | index. | first specified side-lane to a second |
| | | specified side-lane having lowest overall |
| | | costs. The SQE performs a search on the |
| | | topological index to find the lowest-cost |
| | | path through the tree from the node of the |
| | | first side-lane to the node of the second-side |
| | | lane. Any cost-based tree search can be used |
| | | (a depth first search is used in the described |
| | | implementation). |
| | | To obtain the first and second side lanes, |
| | | geometric queries can be used e.g. to find |
| | | the side-lane containing a given point/box or |
| | | the closest side lane to a given point/box. |

For type-specific queries using the above trees, any side-lane attributes that are required are retrieved direct from an in-memory representation of the document containing the static layer 414. A predicate is applied to the entire tree and only those indexed values that satisfy the predicate are considered. A range of predicates may be supported (e.g. lane-type, supporting road-type (in-junction or not), etc.) and arbitrary combinations may also supported, e.g. ‘get me the nearest side-lane that is a driving or a biking lane that is in a junction’.

Road/lane attributes are not stored within the spatial indices in the described examples (but could be in other implementations). Rather, the index is first filtered based on the active predicate(s) and the query is run on the filtered index (such that element that do not satisfy the active predicate(s) are not considered in processing the query).

As will be appreciated, the specific choices of index and query types summarized above are not intended to be exhaustive, but are merely illustrative of how the techniques may be applied in a particular implementation.

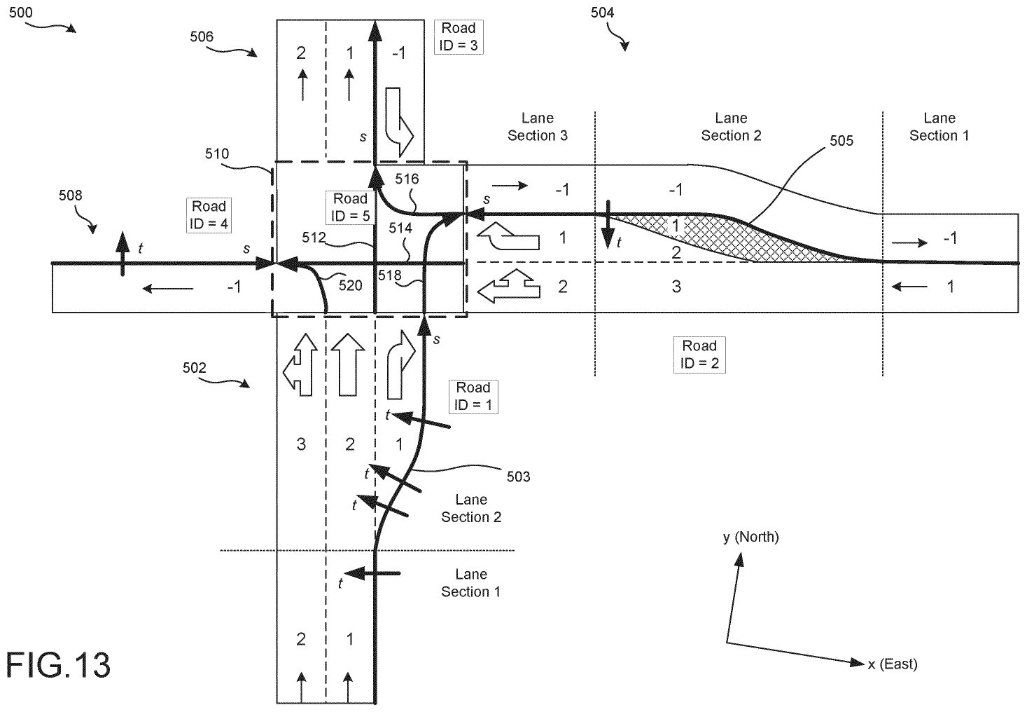

FIG. 13 schematically depicts an example road network 500 of the kind encoded in the static layer 414. The following description assumes the road network 500 is described using the OpenDRIVE schema, or a similar format that adopts certain definitions and conventions from OpenDRIVE. However, it will be appreciated that the principles extend more generally to other formats, and the described techniques are not limited to any particular data format or schema.

The road network 500 is shown to comprise first, second, third and fourth roads 502, 504, 506, 508 (Roads 1 to 4), which are described with <road>elements having road identifiers (IDs) 1, 2, 3 and 4 respectively. The roads 502-508 are interconnected via a junction 510 described by a <junction>element. Each of the roads 502-508 is defined by a single road reference line, denoted as a thick solid arrow, and contains a single center lane of width zero. The center lanes are not depicted separately, and for simplicity it is assumed that the center lane of each road 502-508 lies along the road reference line (although, as noted, it is possible to define a non-zero offset between the road reference line and the center lane). The road reference lines of the first and second roads 502, 504 are denoted by reference numerals 503 and 505 respectively. A road reference line is directional, and could be described more precisely as a longitudinal axis or “s-axis” of the road, with s-coordinates running along that axis, and t-coordinates running orthogonal to it. As depicted for the reference lines 503, 505, the positive t-direction is defined as extending to the left of the s-axis. Lanes are numbered relative to the center lane; the center lane is always numbered 0, with side-lanes to the left of the center lane (+t) assigned incrementing positive lane numbers (1, 2, 3, . . . ) and lanes to the right (−t) assigned decreasing negative lane numbers (−1,−2,−3, . . . ).

Each road has a minimum of one side-lane. In this example, the first road 502 has only positively numbered side-lanes to the left of the center lane, whereas the second road 504 has two positive side-lanes to the left of the center lane, and one negative side-lane to the right. Roads may be divided into “lane sections” to accommodate sections of the road with different numbers of lanes (see below).

In the following description, “Lane n” means a lane with lane number “n” and “Road m” means a road with road ID “m”. Other road elements (such as junctions) are referred to in the same way.

Adjacent lane sections may be referred to as “Lane Section n” and “Lane Section n+1” (the lane section numbers n, n+1 does not form part of the OpenDRIVE schema, but are nevertheless derivable from the static layer 414).

A left-hand traffic (LHT) road system is depicted in this example. However, the schema can be used for either LHT or right-hand traffic (RHT) networks. A “rule” attribute of each <road>element indicates whether the road is LHT (vehicles drive on the left) or RHT (vehicles drive on the right).

A global cartesian coordinate system is defined with the x-direction lying eastwards and the y-axis extending northwards (OpenDRIVE calls this the inertial coordinate system).

Lane numbers only indicate relative directions of traffic flow within a road: for any given road, traffic flows in the same direction for positively-numbered one-way side-lanes, and in the opposite direction for negatively-numbered one-way side-lanes. Bi-directional lanes support traffic flow in both directions irrespective of the road traffic rule. However, the lane number alone is not sufficient to infer the direction of traffic flow, as the direction of the s-axis can be (more or less) arbitrarily chosen and does not indicate driving direction. For example, in FIG. 13, the s-axis 505 of the second road 504 extends towards the junction from the east, whilst the s-axis of the fourth road 508 extends in the opposite direction towards the junction 510 from the west. Along the second road 504, positive lane numbers therefore denote a direction of traffic flow from east to west, whereas along the fourth road 508, east-to-west traffic flow is denoted by negative lane numbers. For a LHT road, lanes to the left of the road reference line (+t) carry traffic in the direction of the road reference line (+s), whereas lanes to the right of the road reference line (−t) carry traffic in the opposite direction (−s). In an RHT road, lanes to the left of the road center line (+t) carry traffic in the opposite direction of the road reference line (−s) and lanes to the right (−t) carry traffic in the direction of the road reference line (+s).

It is also possible to define a bidirectional side-lane, permitting traffic flow in both directions, by setting a @type attribute of the <lane>element to “bidirectional”. Bidirectional lanes are addressed in more detail below.

Therefore, in order to determine the absolute direction of traffic flow, the lane number is not sufficient; the direction of the road reference line (s-axis) must also be considered, as must the @type attribute.

Lanes are not necessarily drivable. For example, Lane 1 of Lane Section 2 of Road 2 is non-drivable. The outer boundaries of a road may also be defined by non-drivable lanes (such as lanes of a pavement/sidewalk type).

Link elements are used to explicitly define linkage between roads and lanes. With only two roads, links can be defined with link elements between roads directly, provided the links are unambiguous. More complex linkage requires the use of junction elements.

A <link>element can have one or both of a <successor>element and a <predecessor>element. The predecessor/successor of a road can be another road or a junction. The predecessor/successor of a lane is another lane. “Predecessor” and “successor” relationships are defined relative to the s-axis of the road in question (a road's t-axis runs from its predecessor, if any, to its successor, if any), and do not denote driving direction. The s-axis of a road runs away from its predecessor (if any), towards its successor (if any).

Predecessor/successor relationships may be ‘asymmetrical’. For example, if Road n is a predecessor of Road m, that does not imply Road m is a successor of Road n; if the s-axis of Road n runs in the opposite direction to the s-axis of Road m, then Road m could also be a predecessor of Road n. As another example, if Road m is part of a junction, then Road m cannot be a predecessor or successor of Road n, because the junction would be the predecessor/successor of Road n instead (see below for further examples).

Roads with varying number of lanes are accommodated using lane sections. Within the OpenDRIVE schema, lanes are described within a <lanes>element of a <road>element. A <lanes>element may be split into multiple sections (lane sections) with a <laneSection>element. Each individual lane is defined by a <lane>element within the <laneSection>element. Each lane section has a fixed number of lanes, numbered as per the above convention. For example, the first road 502 is shown divided into two lane sections (Lane Sections 1 and 2 of Road 1): approaching the junction 510, the number of lanes is shown to increase from two to three. On entering Lane Section 2 from Lane Section 1 of the first road 502, a new rightmost lane is created, whose width gradually increases from zero. In Lane Section 1, the left and right most lanes (to the left of the center lane) are numbered 2 and 1 respectively, whilst in Lane Section 2 the left-most lane and new right-most lanes are numbered 3 and 1 respectively; what is now the middle lane is numbered 2.

Links between lanes in adjacent lane sections are described using <link>elements. In Lane Section 2, Lane 2 of Lane Section 1 is a predecessor of Lane 3 of Lane Section 2, and Lane 1 of Lane Section 1 is a predecessor of Lane 2 of Lane Section 2. That is to say, the lane element describing Lane 3 of Lane Section 2 would contain a link element indicating Lane 2 as its predecessor, and it is implicit that the link refers to the immediately preceding lane section (Lane Section 1) etc.

Likewise, in Lane Section 1, Lane 3 of Lane Section 2 is a successor of Lane 2 of Lane Section 1, and Lane 2 of Lane Section 2 is a successor of Lane 1 of Lane Section 1. That is, the lane element describing Lane 2 of Lane Section 1 would indicate Lane 3 as its successor, and it is implicit that the link refers to the next lane section (Lane Section 2) etc.

Because Lane 1 of Lane Section 2 has zero width initially, it is not linked to any lane of Lane Section 1. It is, however, possible for a lane to have multiple successors or predecessors in different circumstances, for example if a lane splits immediately into two lanes, each of non-zero width at the lane section boundary.

Within the junction element 510 of FIG. 13, additional roads are defined, whose reference lines are depicted as thick, solid arrows. Fifth to ninth roads 512, 514, 516, 518, 520 (Roads 5 to 9) are depicted within the junction 510 in this example. Although side-lanes within the junctions 510 are not depicted in FIG. 13, each road within the junction 510 is also required to have at least one side-lane of non-zero width.

In FIG. 13, the junction 510 is a successor of the first, second and fourth roads 502, 504, 508 because their respective s-axes extend towards the junction 510. Therefore, the <road>elements describing those roads 502, 504, 508 would contain <link>elements with <successor>elements indicating the junction 510. The junction 510 is a predecessor of the third road 506 because its s-axis extends away from the junction, and the <road>element describing the third road 506 would therefore contain a <link>element with a <predecessor>element indicating the junction 510.

Within the junction element 510, connecting roads are described by <road> and <connection>elements.

The fifth road 512 (Road 5) is shown to connect the first and third roads 502, 506. The fifth road 512 is defined by a <road>element within the <junction>element 510, of which the first road 502 is a predecessor and the third road 506 is a successor (defined via <predecessor> and <successor>elements in the <road>element describing the fifth road 506). Similarly the sixth road 514 has the fourth road 508 as its successor and the second road 504 as its predecessor. The seventh road 516 connects the second and third roads 504, 506, with the second road 504 as its predecessor and the third road 506 as its successor. The eighth road 518 connects the second and first roads 504, 502, with the second road 504 as successor and the first road 502 as predecessor. Finally, the ninth road 520 connects the first and fourth roads 502, 508, with the fourth road 508 as its successor and the first road 502 as its predecessor. Again, the predecessor/successor relationships are not direct indicators of driving direction.

A <connection>element is used to indicate driving direction for traffic joining a junction. A connection element indicates an incoming road and a connecting road (but does not explicitly define an outgoing road), with traffic entering the junction from the incoming road onto the connecting road. For example, a first <connection>element would be provided that indicates the road with ID=1 (the first road 502) as an incoming road and the road with ID-5 (the fifth road 512) as a connecting road; this connection element indicates that traffic can enter the junction 510 from the first road 502 onto the fifth road 512. A second <connection>element would indicate the first road 502 as an incoming road and the eighth road 518 as a connecting road, etc. The seventh connecting road 516 is a two-way road in this example, carrying traffic from the second road 504 to the third road 506, and traffic in the opposite direction. Therefore, two <connection>elements would be used, one indicating the second road as incoming and the seventh road 516 as connecting, and the other indicating the third road 506 as incoming and the seventh road 516 as connecting. The OpenDRIVE specification strongly advises one not to use two-way connecting roads, although two-way connecting roads are possible using the schema. The seventh connecting road 516 goes against this advice, but does not violate it (and, in practice, it is more likely that two one-way connecting roads would be defined). The fourth road 508 is not an incoming road to the junction 510 (even though its s-axis extends towards the junction 510), because it is a one-way road that only carries traffic away from the junction 510.

A connecting road with multiple lanes is used when lane changes are possible within the junction 510; if lane changes are not permitted, multiple single-lane roads would be used instead.

A “virtual” connection can also be described using a <connection>element without any connecting road. Virtual connections are limited to “virtual” junctions, which do not require a main road to be split up.

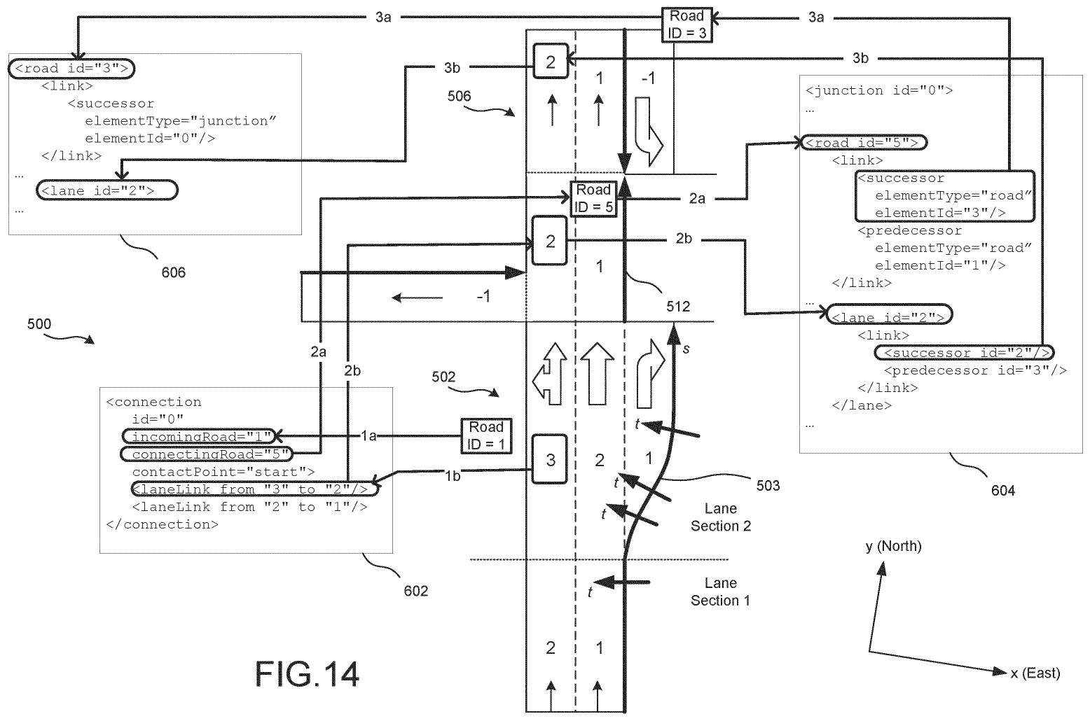

Links between lanes are described via link elements within the <lane>elements that describe those lanes, where predecessor and successor lanes are described in a similar manner to roads. In order for a first lane of a first road to be a predecessor or successor of a second lane of a second road, the second road must be a predecessor or successor of the first road. As the junction 510 is the successor of the first, second and fourth roads 502, 504, 508, these roads 502, 504, 508 have no direct successor roads; therefore, it is not possible for any of their lanes to have lane successors. Likewise, as the junction 510 is the predecessor of the third road 506, the third road 506 has no direct predecessor road; therefore, its lanes cannot have any predecessors. Within the junction 501, however, each of the connecting roads 512-510 has both a direct successor road and a direct predecessor road; for example, the direct successor road of the fifth road 512 is the first road 502 and its direct predecessor is the third road 506. Consequently, lanes of the connecting roads 512-520 can be linked to lanes of both their predecessor and their successor roads. For example, the fifth road 512 would typically contain two positively-numbered side-lanes, 1 and 2. The side-lanes of Road 5 are not depicted in FIG. 13, but are shown in FIG. 14. The lane elements describing lanes 2 and 1 of Road 5 would, in turn, contain link elements, which indicate lane numbers “3” and “2” as their respective predecessors (and it is implicit that these are lanes of Road 5's successor, namely Road 1), and lane numbers “2” and “1” as their respective successors (implicitly referring to Road 5's successor, namely Road 3). A<connection>element also contains any lane.

FIG. 14 shows part of the road network 500 of FIG. 13, annotated with sections of OpenSCENARIO code that define certain elements of the road network.

Starting from any lane of any of the incoming roads 502, 506, 506, the <connection>elements within the junction describe all possible routes though the junction 510 (at the road level). For a given lane on a given road, obtaining a list of all routes through the junction would mean locating all of the <connection>elements that identify the road in question as an incoming road, via its road ID, and which also have a lane linked to the lane in question. To obtain further lane links, it would then be necessary to locate the <road>element of its connecting road, in order to identify the outgoing road (for the fifth road 512, the outgoing road would be the third road 506), and determine the lane linkage between the connecting road and the outgoing road.

A first code portion 602 contains a connection element (connection ID=0) that indicates the first road 502 (the road with ID 1) as an incoming road and the fifth road 512 (the road with ID 5) as a connecting road. First and second <laneLink>elements link Lane 3 of Road 1 (its incoming road) to Lane 2 of Road 5, and Lane 2 of Road 1 to Lane 1 of Road 5. A second portion of code 604 contains the <road>element describing Road 5 within the junction 510 (junction ID=0). A<link>element within the road element contains both <successor> and <predecessor>elements. The road link in the predecessor element indicated Road 1 as the predecessor to Road 5, which mirrors the lane links in the corresponding <connection>element (Connection 0). The successor element indicates the third road 506 (the road with ID 3) as successor to Road 5. A<lane>element is also shown within the road element for Road 5, which describes Lane 2 of Road 5 (other lane elements are omitted for conciseness); the lane element contains a link element, which in turn indicates Lane 2 as its successor and Lane 3 as its predecessor. To meaningfully interpret the lane links, it is necessary to consider the road link information; Road 1 is the predecessor to Road 5, therefore Lane 3 of Road 1 is the predecessor of Lane 2 of Road 5; Road 3 is the successor to Road 5, therefore Lane 2 of Road 3 is the successor to Lane 2 of Road 5. A third code portion 606 contains the road element describing Road 3. The junction 510 (junction ID-0) is indicated as the predecessor to Road 3, and a lane element is shown that describes Lane 2 of Road 3 (other lane elements are omitted for conciseness).

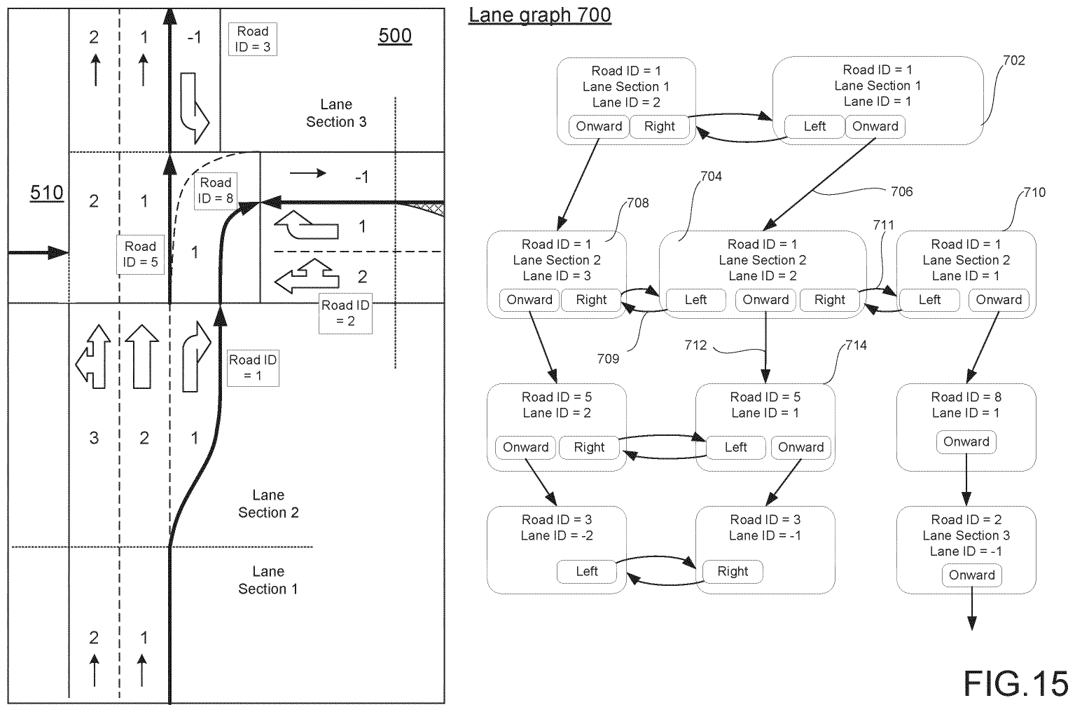

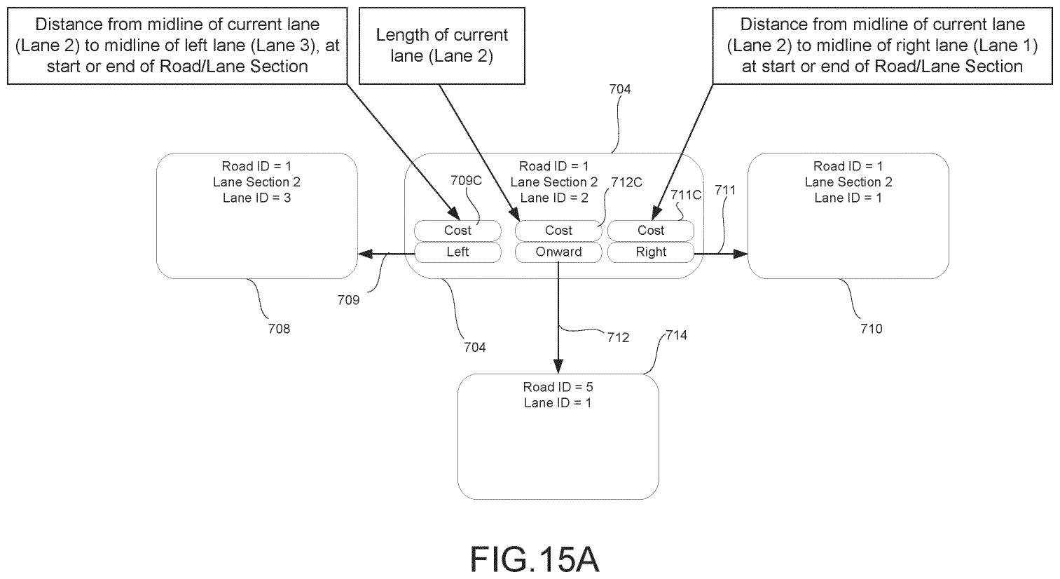

FIG. 15 shows part of a directed side-lane graph 700 representing the road topology of the road network 500. The directed side-lane graph 700 is referred to simply as the lane graph 700 for conciseness. The lane graph 700 describes lane interconnections from Road 1 though the junction 510, and may be derived from the underlying OpenDrive document taking into account the considerations set out above. For example, first and second nodes 702, 704 correspond, respectively, to Lane 1 of Lane Section 1 of Road 1 and Lane 2 of Lane Section 2 of Road 1. An onward edge 706 indicates the topological relationship between those lanes, namely that the latter is an “onward” lane from the former (i.e. a vehicle can traverse from the former to the latter without performing a lane change maneuver). A directed edge from node 702 to node 704 has an edge type describing the connection between the corresponding lanes (“onward” in this case).

The lane graph 700 may be constructed by interpreting the code of the static layer 414. Note that edges of the lane graph denote driving direction. To determine onward edges, lane links need to be considered, but driving direction also needs to be considered.

Edges are also provided for left-right relationships. For example, third and fourth nodes 708, 710 are depicted, representing Lanes 3 and 1, respectively, of Lane Section 2 of Road 1. A right edge 711 from the second node 704 to the fourth node 710 represents the possibility of moving from Lane 2 to Lane 1 of that lane section via a right lane change maneuver. A left edge 709 from the second node 704 to the third node 708 represents the possibility of moving from Lane 2 to Lane 3 via a left lane change maneuver. The left and right edges 709, 711 have respective types (“left” and “right”), again describing the nature of the lane connections. This information is not provided in <link>elements of the underlying description, but can be derived from the structure of the road.

A fifth node 714 represents Lane 1 in the only road section of Road 5, which is an onward lane from Lane 2 in Lane Section 2 or Road 1. Therefore, an onward edge 712 is directed from the second node 704 representing the former to the fifth node 714 representing the latter.

Edges of the lane graph 700 representing driveable connections can be used to infer possible agent goals form a starting node in the lane graph 700 representing the agent's current lane, to determine lanes that are traversable from the agent's current lane up to the predefined depth.

As will be appreciated, there are various ways a graph structure of this nature can be encoded in memory, such that topological relationships within the road network 500 are encoded as in-memory pointers between nodes that represent road structure elements.

In the lane graph 700, a second lane is said to be connected to a first lane if there exists an edge from the first lane to the second lane (implying that it is possible to move from the first lane into the second lane). As indicated, this concept of “connections” in the lane graph is distinct from the concepts of links in OpenDRIVE.

Considering the microplanning query above, topological queries can be accommodated highly efficiently. For example, given a current lane and a goal lane, micro routes from the former to the latter can be easily determined as a set of paths through the lane graph 700 from the node representing the former to the node representing the latter.

Lane sections do not have explicit identifiers in OpenDRIVE. However, they are implicitly indexed by the order in which they appear in the applicable <Road>element. These implicit indices are used to reference Lane Sections within the SQE 402. Specifically, the SQE 402 uses a zero-based index of the lane-section in the road. lanes ( ) lane_sections ( ) collection.

FIG. 15A shows further details of part of the lane graph 700. Each edge has an associated cost stored in association with it. For example, the cost may be contained in the edge descriptor describing that edge. For the sake of illustration, the figure shows costs 709C, 711C and 712C associated with the left, right and onward edges directed from the second node 704 to the third, fourth and fifth nodes 708, 710, 714 respectively. Costs for other edges in the graph are not shown, but each edge of the lane graph 700 is associated with a cost in this manner.

The costs take the form of distance penalties that facilitate a fast search for the shortest micro-route from one node to another. In practice, this search will be approximate. For a given lane sequence, the actual distance travelled will, in practice, have some dependence on driver (or other actor) behaviour, such as the timing of lane change maneuvers, the extent of lateral movement within a lane etc., Nevertheless, it is possible to assign each edge of the graph 700 a cost that is generally representative of distance travelled.

When an onward edges in the directed side-lane graph 700 is traversed, a cost is incurred that is equal to the physical length of the source side-lane mid-line (measured from the beginning of the supporting lane-section). That is, for an onward edge from one lane to another, it is the length (longitudinal extent) of the former that is material. Thus, the distance penalty 712C associated with the onward edge from the second node 704 to the fifth node 714 depends on the length of Lane 2 in Lane Section 2 of Road 1. Conceptually, route planning from a given node (at the start of a route or along a route) begins at the start of the lane, as defined by driving direction. To reach an onward lane from the start of a current lane requires the given lane to be driven (or otherwise traversed) in order to reach the onward lane. Hence, to support this form of route planning, the cost of an onward edge from a current lane to an onward lane is given by the length of the current lane (not the onward lane), or any suitable function of the length of the current lane.

When a neighbouring edge in the lane graph 700 is traversed, a cost is incurred that is equal to the distance between the supporting side-lane mid-lines. That is, for a left or right edge, lateral distance is material. For example, the cost of a left or right edge from a current lane to a neighbouring (left or right) lane may be a lateral distance between the current lane and the neighbouring lane. The lateral distance need only be approximate and generally representative of the additional travel distance incurred by a lane change. Indeed, one aim is to prevent a cost-based search of the graph from returning routes with excessive left-right lane changes (e.g. switch back and forth between the same two lanes repeatedly), and to achieve this, any non-zero cost of sufficient magnitude may be used (because each ‘unnecessary’ left/right lane change adds to the overall cost).

The point at which the lateral distance is measured is arbitrary, and one option is to use the maximum of the inter side-lane mid-line distance at the start and the end of the supporting lane-section (to keep it symmetric). In this case, the distance penalty for a left/right edge is taken as the lateral separation between the current lane and the neighbouring lane (or some function thereof) at the start of the current lane or the end of the current lane (whichever is greater). Ideally one might want to use something more representative of any excess arclength introduced by making the lane-change, but the simpler heuristic it is sufficient for the current purposes. In any event, as noted, any lateral distance penalty sufficient to prevent repeated or unnecessary left/right lane changes may be sufficient.

It will be appreciated that distance-based costs can be constructed in other ways, and that the exact choice will be implementation-specific. In the context of a route planning query, distance-based costs need only be generally representative of travel distances associated with lane changes (in the broad sense), with the aim of finding an approximate shortest route (in the geometric sense) between any two given nodes of the graph 700. Other forms of cost may also be defined to support other types of topological query. In this context, although the query and the lane graph 700 are topological in nature, the costs are based on lane geometry. Geometric costs allow geometric information to feed into topological queries without compromising runtime performance.

As noted, one example of a topological query at the SQE API 403 is a route-planning query that provides descriptors 423 of a desired start lane and a desired end lane. In order to respond to this query, a depth-first search is performed, taking into account the edge costs, with the aim of finding the lowest-cost route (lane sequence) from the start lane to the end lane. This will not necessarily be the route with the fewest lane changes; although the query is topological in nature, the costs are based on lane geometry. Although the costs generally discourage lane changes, it is the overall cost that matters. For example, in a road with high curvature, a lane closer to the center of curvature may be materially shorter (longitudinally) than a lane further from it (one concrete example being a roundabout; the innermost lane of a roundabout may be significantly shorter that the outermost lane). In this case, the additional penalty incurred by one or more left or right lane changes may be less the “saving” gained by choosing a shorter lane closer to the center of curvature.

In a goal extraction context, as noted, agent goals may be extracted in a similar search methodology, but for all possible lane graph traversals from the agent's current position up to a defined depth.

### Experiments

We evaluate an implementation of the described system on the Next Generation Simulation (NGSIM) dataset [12], which is seen as a standard for highway scenarios. NGSIM includes vehicle trajectory data acquired from two US highways, US-101 and I-80, using CCTV cameras and a semi-automatic annotation process. Each dataset part was captured at 10 Hz over a time span of 45 min and consists of 15 min segments of mild, moderate and congested traffic conditions. The dataset provides the coordinates of vehicles in UTM and a local reference system. We used UTM coordinates for alignment with our geo-referenced OpenDrive map annotations. As in previous related works [6], we split the datasets into train (70%), validation (10%) and test (20%) based on the vehicle ID. Each vehicle from each split is chosen as the target vehicle, defining one sample. We split the trajectories of the target vehicle into segments of 8 s, where we use 3 s of history and a 5 s prediction horizon. The system hyper-parameters were tuned using randomised search on the training set.

### A. Overall System Evaluation

We compare the present system with other multimodal prediction methods using two standard trajectory error metrics, Root Mean Squared Error (RMSE) and Final Displacement Error (FDE). As in [7], they are calculated by comparing the ground truth trajectory with the most likely (highest probability) trajectory. Lower scores are better. Table I includes the numerical comparison. Both RMSE and FDE scores of our system are lower than that of a simpler baseline, the Constant Velocity (CV) model [25], as well as that of other deep learning methods, CSP (M) [6] and PiP [8], for all time horizons. FDE for PiP is not reported in the original paper. We outperform the closest competitor SAMMP [7] for most time horizons (3 s, 4 s, 5 s). Our system is comparable to the best state-of-the-art for shorter and easier horizons (1 s, 2 s, 3 s) and significantly improve over the longer, more difficult horizons (4 s, 5 s), needed for motion planning [2].

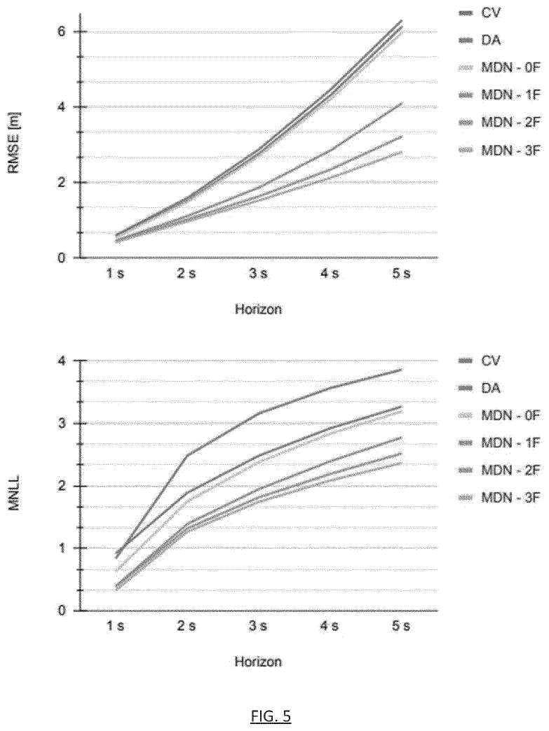

FIG. 5 shows RMSE and MNLL comparison of follow-lane models for motion profile prediction. Models considering more front agents are more accurate.

### B. Motion Profile Prediction Analysis

The previously reported overall error can be caused by several factors. In this section, we focus on what we observed to be the most significant contributor: motion profile prediction. In addition to the previously reported dataset pre-processing steps, we split the dataset based on the observed behaviour of the agent being predicted: follow-lane and change-lane. We evaluate the motion profile prediction component using the RMSE and Mean Negative Log Likelihood (MNLL) errors on the predicted future distance. MNLL takes uncertainty into account [6]. We adapt the RMSE to compute it on a single dimension. The NLL is already defined in Equation 2, where the displacement error at time t for a Gaussian component m centered at d̅_{m.t} is ∈_{m.t}=d_{m.t}−d̅_{m.t}. We average across the dataset to compute the MNLL value.

FIG. 5 shows the relative performance of different follow-lane motion profile prediction models. We compared each neural network in the collection with physics-based methods: Constant Velocity (CV) and Decaying Acceleration (DA). We model the physics-based model uncertainty at each predicted time step using standard deviations and modelling the errors of the CV or DA assumption with a centered Gaussian distribution at each time step. Neural networks outperform physics-based models. Considering more agents leads to lower errors since traffic dynamics, such as safe distancing, stop and go motion and motion initiation, can be modelled. For example, we observed that considering 3 front agents instead of 0 reduces motion initiation errors; RMSE and MNLL at 5 s decrease by 3.21 m and 0.50 respectively.

We analysed the relative performance of different changelane motion profile prediction models. We report the weighted RMSE and MNLL at 5 s for brevity. We averaged the performance on each dataset split, varying the number of front and side agents. The collection (RMSE 7.14 m, MNLL 3.44) always improves over physics-based models CV (RMSE 10.09 m, MNLL 4.02) and DA (RMSE 9.81 m, MNLL 3.84). In addition, Tables II and III report the performance of each change-lane network in the collection for further analysis. Even though the attention of a driver performing a change-lane should be on what happens in both the current and target lane, we observe that the performance of the change-lane networks is mainly influenced by the number of side agents. The performance of the change-lane networks is not influenced by the number of front agents as much as the performance of the follow-lane networks. The most difficult cases for all change-lane models, including physics-based models, involve fewer number of side agents. Our interpretation is that the number of ways one can perform a change-lane is reduced in congested situations, simplifying the prediction task. Furthermore, the RMSE values vary a lot with number of side agents in comparison to the MNLL values. The cases with few agents have more variability, which is captured by our system handling of uncertainty as confirmed by the MNLL values.

### C. Qualitative Analysis

One major advantage of the system 100 is the ability to inspect each component, allowing to debug and understand their contributions to the overall performance. Here, we show how we can debug and interpret the output of the Bayesian inference component. We also provide insight in the advantages of combining the neural networks with a classical trajectory generator. We illustrate the Bayesian inference process of inferring the goal of the target agent in FIG. 6. For ease of visualisation, we use a constant velocity motion profile prediction model and we do not show the neighbour agents as this context information is handled in the trajectory generator component. In the first observation, the most likely behaviour is a follow-lane as the change-lane-left and exit-right contain high lateral acceleration values, reducing their likelihood. After a couple of observations, the vehicle has turned towards the exit, causing the change left to be predicted as highly unlikely. Follow-lane is still very probable as the vehicle has not gone far from the centre of the lane. After another pair of observations, the follow-lane becomes unlikely due to the large lateral acceleration values. The final observation results in a large probability in the exit behaviour, while the other behaviours have low values. The forgetting factor aids in quickly responding in the event of a goal change as these values do not go below a minimum. In addition to the known unpredictability of neural network performance [35], the training data can be noisy. Due to this combination, their output is likely to violate our acceleration and jerk limits. To illustrate the impact of these limits, we measure the number and magnitude of violations. The predicted trajectory closest to the ground truth trajectory is used for these measurements. On the motion profile validation dataset made of approximately 840 k samples, we observed 38 acceleration violations and 241 k jerk violations that were corrected by the limits. The mean of the acceleration violation is 2.52 m/s² with standard deviation 1.86 m/s². The mean of the jerk violation is 12.30 m/s³ with standard deviation 8.01 m/s³. We also noticed that introducing the limits did not significantly impact the overall performance of the system. Previous work [5] has also reported that the path output of neural networks can violate the constraints of a vehicle model. These concerns are important since a prediction system that produces infeasible trajectories can negatively impact the performance of the components down the line, e.g. planning. FIG. 7 shows that the combination of neural networks with kinematic and motion profile constraints can address these concerns. Even though the ground truth trajectory is not feasible, the prediction output is. Furthermore, the green trajectory is the one with the highest probability.

### D. Runtime Analysis

The inference runtime of the system was measured with a desktop PC equipped with an Intel Core i7-7800X CPU 3.50 GHz over a set of 1000 samples chosen arbitrarily from the dataset. Our full system which runs on CPU is implemented in C++ and Python. It takes approximately 5.5 ms per call for each agent and we provide a breakdown of the components cost in Table IV. Given our code structure, the time reported for the Bayesian inference component includes the time for generating trajectories with the pure pursuit algorithm. The feature extraction step is currently the bottleneck as it is Python code which can be further optimised. Training the mixture of experts collection in Tensorflow requires approximately 32.5 minutes on the full training dataset on CPU while other methods report training times of several hours using the same dataset and high-end GPUs, e.g. 17.5 hours [9] or 1 day [37].

The efficacy of a motion prediction system based on a modular architecture involving both data-driven and analytically modelled components has thus been demonstrated. We showed that it achieves state-of-the-art results in the highway driving setting. The system covers multiple aspects of interest, namely multi-modality, physical feasibility, motion profile uncertainty, system maintainability and efficiency.

TABLE I
Overall system comparison on the NGSIM test set
using RMSE and FDE of the most likely trajectory.

| Time Horizon | | 1 s | 2 s | 3 s | 4 s | 5 s |
|---|---|---|---|---|---|---|
| RMSE [m] | CV [25] | 0.76 | 1.82 | 3.17 | 4.80 | 6.70 |
| | CSP(M) [6] | 0.59 | 1.27 | 2.13 | 3.22 | 4.64 |
| | PiP [8] | 0.55 | 1.18 | 1.94 | 2.88 | 4.04 |
| | SAMMP [7] | 0.51 | 1.13 | 1.88 | 2.81 | 3.98 |
| | Flash | 0.51 | 1.15 | 1.84 | 2.64 | 3.62 |
| FDE [m] | CV [25] | 0.46 | 1.24 | 2.27 | 3.53 | 4.99 |
| | CSP(M) [6] | 0.39 | 0.91 | 1.55 | 2.36 | 3.39 |
| | SAMMP [7] | 0.31 | 0.78 | 1.35 | 2.04 | 2.90 |
| | Flash | 0.33 | 0.82 | 1.34 | 1.91 | 2.61 |

TABLE II
Comparison of change-lane motion profile prediction
models on the NGSIM test set using RMSE at 5 s

| | # Side | | | |
|---|---|---|---|---|
| # Front | 0 | 1 | 2 | 3 |
| 0 | 10.05 | 7.54 | 6.45 | 5.13 |
| 1 | 9.49 | 7.71 | 6.44 | 5.13 |
| 2 | 9.50 | 7.05 | 6.15 | 5.06 |
| 3 | 8.98 | 8.09 | 6.14 | 5.25 |

TABLE III
Comparison of change-lane motion profile prediction
models on the NGSIM test set using MNLL at 5 s.

| | # Side | | | |
|---|---|---|---|---|
| # Front | 0 | 1 | 2 | 3 |
| 0 | 3.82 | 3.44 | 3.24 | 3.04 |
| 1 | 3.83 | 3.52 | 3.39 | 3.00 |
| 2 | 3.74 | 3.34 | 3.33 | 3.01 |
| 3 | 3.56 | 3.77 | 3.68 | 3.28 |

TABLE IV
Running times [ms] per component call.

| Data processing | Motion Profile Prediction | Bayesian Inference |
|---|---|---|
| 3.3 | 1.8 | 0.4 |

It will be appreciated that the term “stack” encompasses software, but can also encompass hardware. A stack may be deployed on a real-world vehicle, where it processes sensor data from the on-board sensors, and controls the vehicle's motion via the actor system 112.

References herein to agents, vehicles, robots and the like include real-world entities but also simulated entities. The techniques described herein have application on a real-world vehicle, but also in simulation-based autonomous vehicle testing. For example, the inverse planning prediction method may be performed within the prediction system 104 when the stack 100 is tested in simulation. As another example, the stack 100 may be used to plan ego trajectories/plans to be used as a benchmark for other AV stacks. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like). The subsystems 102-108 of the runtime stack of Figure C may be implemented in programmable or dedicated processor(s), or a combination of both, on-board a vehicle or in an off-board computer system in the context of testing and the like.

### REFERENCES

Each of the following is incorporated herein by reference in its entirety:
[1] C. Hubmann, J. Schulz, G. Xu, D. Althoff, and C. Stiller, “A belief state planner for interactive merge maneuvers in congested traffic,” in 2018 21st International Conference on Intelligent Transportation Systems (ITSC), pp. 1617-1624, 2018.
[2] S. V. Albrecht, C. Brewitt, J. Wilhelm, B. Gyevnar, F. Eiras, M. Dobre, and S. Ramamoorthy, “Interpretable goal-based prediction and planning for autonomous driving,” in 2021 IEEE International Conference on Robotics and Automation (ICRA), pp. 1043-1049, IEEE, 2021.
[3] F. Eiras, M. Hawasly, S. V. Albrecht, and S. Ramamoorthy, “A twostage optimization-based motion planner for safe urban driving,” IEEE Transactions on Robotics, 2021.
[4] N. Rhinehart, J. He, C. Packer, M. A. Wright, R. McAllister, J. E. Gonzalez, and S. Levine, “Contingencies from observations: Tractable contingency planning with learned behavior models,” in IEEE International Conference on Robotics and Automation, ICRA 2021, pp. 13663-13669, IEEE, 2021.
[5] H. Girase, J. Hoang, S. Yalamanchi, and M. Marchetti-Bowick, “Physically feasible vehicle trajectory prediction,” arXiv preprint arXiv: 2104.14679, 2021.
[6] N. Deo and M. M. Trivedi, “Convolutional social pooling for vehicle trajectory prediction,” in Proceedings of the IEEE Conference on Computer Vision and Pattern Recognition Workshops, pp. 1468-1476, 2018.
[7] J. Mercat, T. Gilles, N. El Zoghby, G. Sandou, D. Beauvois, and G. P. Gil, “Multi-head attention for multi-modal joint vehicle motion forecasting,” in 2020 IEEE International Conference on Robotics and Automation (ICRA), pp. 9638-9644, IEEE, 2020.
[8] H. Song, W. Ding, Y. Chen, S. Shen, M. Y. Wang, and Q. Chen, “Pip: Planning-informed trajectory prediction for autonomous driving,” in European Conference on Computer Vision, pp. 598-614, Springer, 2020.
[9] B. Mersch, T. Hollen, K. Zhao, C. Stachniss, and R. Roscher, “Maneuver-based trajectory prediction for self-driving cars using spatio-temporal convolutional networks,” in 2021 IEEE/RSJ International Conference on Intelligent Robots and Systems (IROS), pp. 4888-4895, IEEE, 2021.
[10] D. Sculley, G. Holt, D. Golovin, E. Davydov, T. Phillips, D. Ebner, V. Chaudhary, and M. Young, “Machine learning: The high interest credit card of technical debt,” 2014.
[11] A. R. Srinivasan, M. Hasan, Y.-S. Lin, M. Leonetti, J. Billington, R. Romano, and G. Markkula, “Comparing merging behaviors observed in naturalistic data with behaviors generated by a machine learned model,” in 2021 IEEE International Intelligent Transportation Systems Conference (ITSC), pp. 3787-3792, IEEE, 2021.
[12] J. Colyar and J. Halkias, “Us highway 101 dataset,” Federal Highway Administration (FHWA), Tech. Rep. FHWA-HRT-07-030, pp. 27-69, 2007.
[13] C. L. Baker, R. Saxe, and J. B. Tenenbaum, “Action understanding as inverse planning,” Cognition, vol. 113, no. 3, pp. 329-349, 2009.
[14] M. Ram'irez and H. Geffner, “Probabilistic plan recognition using offthe-shelf classical planners,” in 24th AAAI Conference on Artificial Intelligence, pp. 1121-1126, 2010.
[15] J. P. Hanna, A. Rahman, E. Fosong, F. Eiras, M. Dobre, J. Redford, S. Ramamoorthy, and S. V. Albrecht, “Interpretable goal recognition in the presence of occluded factors for autonomous vehicles,” in 2021 IEEE/RSJ International Conference on Intelligent Robots and Systems (IROS), pp. 7044-7051, IEEE, 2021.
[16] Y. Luo, P. Cai, Y. Lee, and D. Hsu, “Gamma: A general agent motion model for autonomous driving,” arXiv: 1906.01566 [cs], 2022.
[17] D. Gonzalez, J. P ‘erez, V. Milan’ es, and F. Nashashibi, “A review of mo-‘tion planning techniques for automated vehicles,” IEEE Transactions on Intelligent Transportation Systems, vol. 17, no. 4, pp. 1135-1145, 2016.
[18] T. Buhet, E. Wirbel, A. Bursuc, and X. Perrotton, “PLOP: probabilistic’ polynomial objects trajectory prediction for autonomous driving,” in CoRL, vol. 155 of Proceedings of Machine Learning Research, pp. 329-338, PMLR, 2020.
[19] R. C. Coulter, “Implementation of the pure pursuit path tracking algorithm,” tech. rep., Carnegie-Mellon UNIV Pittsburgh PA Robotics INST, 1992.
[20] S. Lefevre, C. Sun, R. Bajcsy, and C. Laugier, “Comparison of para-′ metric and non-parametric approaches for vehicle speed prediction,” in 2014 American Control Conference, pp. 3494-3499, IEEE, 2014.
[21] M. Treiber, A. Hennecke, and D. Helbing, “Congested traffic states in empirical observations and microscopic simulations,” Physical review E, vol. 62, no. 2, p. 1805, 2000.
[22] A. Kesting, M. Treiber, and D. Helbing, “General lane-changing model mobil for car-following models,” Transportation Research Record, vol. 1999, no. 1, pp. 86-94, 2007.
[23] J. Bernhard and A. C. Knoll, “Risk-constrained interactive safety under behavior uncertainty for autonomous driving,” in IV, pp. 63-70, IEEE, 2021.
[24] C. M. Bishop, “Mixture density networks,” 1994.
[25] J. Mercat, N. E. Zoghby, G. Sandou, D. Beauvois, and G. P. Gil, “Kinematic single vehicle trajectory prediction baselines and applications with the ngsim dataset,” arXiv preprint arXiv: 1908.11472, 2019.
[26] A. Alahi, K. Goel, V. Ramanathan, A. Robicquet, L. Fei-Fei, and S. Savarese, “Social 1stm: Human trajectory prediction in crowded spaces,” in 2016 IEEE Conference on Computer Vision and Pattern Recognition (CVPR), pp. 961-971, 2016.
[27] Y. Chai, B. Sapp, M. Bansal, and D. Anguelov, “Multipath: Multiple probabilistic anchor trajectory hypotheses for behavior prediction,” in 3rd Annual Conference on Robot Learning, CoRL 2019, Osaka, Japan, Oct. 30-Nov. 1, 2019, Proceedings, pp. 86-99, 2019.
[28] J. Gao, C. Sun, H. Zhao, Y. Shen, D. Anguelov, C. Li, and C. Schmid, “Vectornet: Encoding HD maps and agent dynamics from vectorized representation,” in 2020 IEEE/CVF Conference on Computer Vision and Pattern Recognition, CVPR 2020, Seattle, WA, USA, Jun. 13-19, 2020, pp. 11522-11530, 2020.
[29] F. Chou, T. Lin, H. Cui, V. Radosavljevic, T. Nguyen, T. Huang, M. Niedoba, J. Schneider, and N. Djuric, “Predicting motion of vulnerable road users using high-definition maps and efficient convnets,” in IEEE Intelligent Vehicles Symposium, I V 2020, Las Vegas, NV, USA, Oct. 19-Nov. 13, 2020, pp. 1655-1662, IEEE, 2020.
[30] L. Zhang, P. Su, J. Hoang, G. C. Haynes, and M. Marchetti-Bowick, “Map-adaptive goal-based trajectory prediction,” in 4th Conference on Robot Learning, CoRL 2020, 16-18 November 2020, Virtual Event/Cambridge, MA, USA (J. Kober, F. Ramos, and C. J. Tomlin, eds.), vol. 155 of Proceedings of Machine Learning Research, pp. 1371-1383, PMLR, 2020.
[31] C. Brewitt, B. Gyevnar, S. Garcin, and S. V. Albrecht, “GRIT: fast, interpretable, and verifiable goal recognition with learned decision trees for autonomous driving,” in IEEE/RSJ International Conference on Intelligent Robots and Systems (IROS), 2021.
[32] S. Shalev-Shwartz, S. Shammah, and A. Shashua, “On a formal model of safe and scalable self-driving cars,” CoRR, vol. abs/1708.06374, 2017.
[33] M. Dupuis, M. Strobl, and H. Grezlikowski, “Opendrive 2010 and beyond-status and future of the de facto standard for the description of road networks,” in Proc. of the Driving Simulation Conference Europe, pp. 231-242, 2010.
[34] L. Rokach, Pattern classification using ensemble methods, vol. 75. World Scientific, 2010.
[35] A. Filos, P. Tigkas, R. Mcallister, N. Rhinehart, S. Levine, and Y. Gal, “Can autonomous vehicles identify, recover from, and adapt to distribution shifts?,” in International Conference on Machine Learning, vol. 119, pp. 3145-3153, PMLR, November 2020.
[36] H. Pulver, F. Eiras, L. Carozza, M. Hawasly, S. V. Albrecht, and S. Ramamoorthy, “PILOT: Efficient planning by imitation learning and optimisation for safe autonomous driving,” arXiv: 2011.00509 [cs], November 2020.
[37] C. Tang and R. R. Salakhutdinov, “Multiple futures prediction,” Advances in Neural Information Processing Systems, vol. 32, pp. 15424-15434, 2019.

1. A computer-implemented method of predicting agent motion, the method comprising:
receiving a first observed agent state corresponding to a first time instant;
determining a set of agent goals for an agent located in a road layout having an associated lane graph, by performing a search of the associated lane graph based on the first observed agent state;
for each agent goal, planning at least one agent trajectory based on the agent goal and the first observed agent state;
receiving a second observed agent state corresponding to a second time instant later than the first time instant; and
for each goal, comparing the second observed agent state with the at least one agent trajectory planned for the goal, and thereby computing a likelihood of the goal and/or the planned agent trajectory for the goal.

2. The method of claim 1, wherein the search of the associated lane graph comprises exploring traversals through the lane graph from the second observed agent state up to a predetermined distance.

3. The method of claim 1, repeated over a sequence of time steps, with the second observed agent state in a given time step becoming the first observed agent state in a next time step.

4. The method of claim 3, wherein each goal is defined as a sequence of lane identifiers determined from the lane graph, wherein at least one goal is matched with a goal extracted in a previous time step by comparing the respective sequences of lane identifiers defining those goals.

5. The method of claim 1, comprising comparing the second observed agent with the agent trajectory, by determining a probability distribution based on a predicted state of the agent trajectory corresponding to the second time instant, and computing a likelihood of the second observed agent state based on the probability distribution.

6. The method of claim 5, wherein a goal or trajectory posterior probability is computed based on the likelihood of the goal and a prior for the goal or trajectory, and where the method is repeated over a sequence of time steps with the second observed agent state in a given time step becoming the first observed agent state in a next time step, the goal or trajectory prior is based on a goal or trajectory posterior probability from a previous time step.

7. (canceled)

8. The method of claim 6, wherein each goal is defined as a sequence of lane identifiers determined from the lane graph, wherein at least one goal is matched with a goal extracted in a previous time step by comparing the respective sequences of lane identifiers defining those goals, and wherein the goal or trajectory prior of the at least one goal is based on the goal or trajectory posterior probability of the goal from the previous time step to which it has been matched.

9. The method of claim 7, wherein the goal or trajectory posterior probability from the previous time step is smoothed with a forgetting factor.

10. The method of claim 6, wherein responsive to a change in the set of agent goals relative to the previous time step, the change being a removal of a goal that is no longer achievable or addition of a new goal, the goal or trajectory posterior for each remaining goal or trajectory is updated to account for the removed goal or the new goal.

11. The method of claim 1, wherein the goal or trajectory likelihood is biased by applying a weighting factor that penalizes the planned agent trajectory for lack of comfort.

12. The method of claim 11, wherein the weighting factor penalizes lateral acceleration on the planned agent trajectory that is above a lateral acceleration threshold.

13. The method of claim 1, wherein the agent trajectory is planned using a target path extracted based on a geometry of the road layout and a motion profile generated using a neural network.

14. The method of claim 13, wherein the neural network generates the motion profile but does not generate any path, wherein the target path and the motion profile are provided to a classical trajectory planner which plans the agent trajectory based on the motion profile and the target path.

15. The method of claim 14, wherein the classical trajectory planner uses a controller and an agent dynamics model to generate a trajectory that minimises error from the motion profile and the target path.

16. The method of claim 13, comprising determining a context for the agent, and selecting the neural network from a collection of neural networks based on the determined context.

17. The method of claim 16, wherein the context is based on the goal and a number of other agents surrounding the agent.

18. A computer system comprising:
at least one memory configured to store computer-readable instructions;
at least one hardware processor coupled to the at least one memory and configured to execute the computer-readable instructions, which upon execution cause the at least one hardware processor to perform operations including:
receiving a first observed agent state corresponding to a first time instant;
determining a set of agent goals;
for each agent goal, planning an agent trajectory based on the agent goal and the first observed agent state;
receiving a second observed agent state corresponding to a second time instant later than the first time instant;
for each goal, comparing the second observed agent state with the at least one agent trajectory planned for the goal, and thereby computing an unbiased likelihood of the goal and/or the planned agent trajectory for the goal; and
obtaining a biased likelihood by applying a weighting factor to the unbiased likelihood that penalizes lack of comfort.

19-23. (canceled)

24. A non-transitory medium embodying computer-readable instructions which, when executed by one or more hardware processors, cause the one or more hardware processors to performing operations including: generating an agent trajectory for a mobile agent based on an agent goal, using a target path extracted based on a geometry of a road layout and a motion profile generated using a neural network.

25-27. (canceled)

28. The medium of claim 24, wherein the neural network receives as input a set of agent features and a representation of the target path.

29. (canceled)

30. The medium of claim 24, wherein the operations further comprise, for use in planning motion of the mobile agent, the method comprising-generating based on the generated trajectory a control signal for controlling motion of the mobile agent.

31. The medium of claim 24, for use in predicting motion of the mobile agent for planning motion of an ego agent, wherein a planner of an autonomous stack receives the generated trajectory for the mobile agent and uses the generated trajectory to plan an ego agent trajectory.

32. The medium of claim 24, wherein a lane graph is a directed graph comprising nodes representing lanes and edges between the nodes representing directed lane connections between lanes.

33-34. (canceled)

35. The medium of claim 24, wherein an agent trajectory is generated for each goal of a set of agent goals, based on the agent goal and a first observed agent state corresponding to a first time instant, and the agent trajectory for each goal is compared to a second observed agent state, corresponding to a second time instant later than the first time instant, so as to compute a likelihood of the goal and/or the generated agent trajectory for the goal.
